(19) United States
(12) Patent Application Publication
(10) Pub. No.: US 2025/0341001 A1
(43) Pub. Date: Nov. 6, 2025

(54) GREEN HYDROGEN FROM SEAWATER

(71) Applicant: The Regents of the University of California, Oakland, CA (US)

(72) Inventors: John Koster, Santa Cruz, CA (US); Soren Tornoe, Santa Cruz, CA (US); Donald Potts, Santa Cruz, CA (US); Nobuhiko Kobayashi, Santa Cruz, CA (US)

(73) Assignee: The Regents of the University of California, Oakland, CA (US)

(21) Appl. No.: 18/870,002

(22) PCT Filed: Jun. 1, 2023
(86) PCT No.: PCT/US2023/067744

§ 371 Date: Nov. 27, 2024

Related U.S. Application Data
(60) Provisional application No. 63/347,891, filed on Jun. 1, 2022.
(60) Provisional application No. 63/425,632, filed on Nov. 15, 2022.

(51) Int. Cl. C25B 1/04; C25B 9/63; C25B 9/65; C25B 9/70; C25B 13/00; C25B 15/023; C25B 15/04; C25B 15/08

(52) U.S. Cl. CPC C25B 1/04; C25B 9/63; C25B 9/65; C25B 9/70; C25B 13/00; C25B 15/023; C25B 15/04; C25B 15/083

(57) ABSTRACT

An electrode configuration and system useful for performing electrolysis, including one or more pairs of non-planar electrodes each comprising a first electrode having a first base and a second electrode comprising a second base. A mount can be used to mount the first electrode and the second electrode in each of the pairs with a spacing between the first base and the second base, so that an electric current may flow through a fluid between the first base and the second base to drive an electrochemical reaction of the fluid. A surface area of the bases (the base of the first electrode and the base of the second electrode) exposed to the fluid are dimensioned to support a current density of the electric current of at least 10 A/cm² or in a range of 10 A/cm² and 14 A/cm². An electrolysis system including the electrodes can be used for the electrolysis of seawater to produce hydrogen at higher rates and with reduced chlorine evolution.

### CROSS REFERENCE TO RELATED APPLICATIONS

This application claims the benefit under 35 U.S.C. Section 119 (e) of the following co-pending and commonly-assigned applications:
U.S. Provisional Application Ser. No. 63/347,891, filed on Jun. 1, 2022, by John Koster, Soren Tornoe, Donald Potts, and Nobuhiko Kobayashi, entitled “GREEN HYDROGEN FROM SEAWATER,” Attorney's Docket Number 284.0012USP1; and
U.S. Provisional Application Ser. No. 63/425,632, filed on Nov. 15, 2022, by John Koster, Soren Tomoc, Donald Potts, and Nobuhiko Kobayashi, entitled “USING ARRAYS OF MICROELECTRODES IN ELECTROLYSIS TO TAILOR ELECTROCHEMICAL REACTIONS BY HIGHER ELECTRICAL CURRENT DENSITY AND ELECTRICAL POTENTIAL GRADIENT,” Attorney's Docket Number 284.0012USP2;
both of which applications are incorporated by reference herein.

This application is related to PCT international patent application Serial No. XXXXXXX, filed on same date herewith, by John Koster, Soren Tornoe, Donald Potts, and Nobuhiko Kobayashi, entitled “NOVEL TECHNIQUE TO QUANTIFY GASEOUS REACTIVE CHLORINE SPECIES BYLIQUID ION CHROMATOGRAPY,” Attorney's Docket Number 284.0016WOU1; which application claims the benefit under 35 U.S.C. Section 119 (e) of
U.S. Provisional Application Ser. No. 63/347,891, filed on Jun. 1, 2022, by John Koster, Soren Tornoe, Donald Potts, and Nobuhiko Kobayashi, entitled “GREEN HYDROGEN FROM SEAWATER,” Attorney's Docket Number 284.0012USP1; and
U.S. Provisional Application Ser. No. 63/425,632, filed on Nov. 15, 2022, by John Koster, Soren Tornoe, Donald Potts, and Nobuhiko Kobayashi, entitled “USING ARRAYS OF MICROELECTRODES IN ELECTROLYSIS TO TAILOR ELECTROCHEMICAL REACTIONS BY HIGHER ELECTRICAL CURRENT DENSITY AND ELECTRICAL POTENTIAL GRADIENT,” Attorney's Docket Number 284.0012USP2; and
U.S. Provisional Application Ser. No. 63/425,635, filed on Nov. 15, 2022, by John Koster, Soren Tomoe, Donald Potts, and Nobuhiko Kobayashi, entitled “NOVEL TECHNIQUE TO QUANTIFY GASEOUS REACTIVE CHLORINE SPECIES BYLIQUID ION CHROMATOGRAPY,” Attorney's Docket Number 284.0016USP1;
which applications are incorporated by reference herein.

### BACKGROUND OF THE INVENTION

### 1. Field of the Invention

The present invention relates to methods and systems for performing and controlling electrochemical reactions such as electrolysis.

### 2. Description of Related Art

Efficient methods of generating hydrogen are needed to fuel the hydrogen economy [1]. One potential method involves the extraction of hydrogen from seawater via electrolysis. However, since its discovery in 1800, the main stumbling block for efficient saline water electrolysis has been the distinct kinetic advantage chlorine has over oxygen during the electrochemical reactions taking place at the anode (i.e., Chlorine Evolving Reaction CER versus Oxygen Evolving Reaction). Chloride is the most prevalent negative ion in seawater, thus resulting in large proportions of toxic Ch gas being evolved at the anode. Analogous bromine species having even stronger noxious properties are also produced, although in much lesser and difficult to measure concentration.

Conventional techniques for seawater electrolysis focus on finessing nanoscale processes using membrane electrolyzers and/or catalytic electrode coatings. The present disclosure reports on a surprisingly different approach tailored to implement electrolysis using significantly higher electromotive force.

### SUMMARY OF THE INVENTION

Embodiments of the present invention include electrode configurations and systems useful for performing electrolysis. Example systems include, but are not limited to, the following.

1 An apparatus, comprising:
one or more non-planar electrodes each comprising a length and a base at the end of the length, wherein:
the base comprises a surface area dimensioned to support a current density of an electric current when a pair of the electrodes are disposed with a spacing between the bases so that the electric current flows through a fluid between the bases to drive an electrochemical reaction of the fluid.

2. The apparatus of example 1, wherein:
the surface area is dimensioned to support the current density of at least 10 Amperes per square centimeter (A/cm²) or in a range of 10 A/cm² and 14 A/cm² (e.g., 10 A/cm²≤J≤14 A/cm²), and/or
the surface area has a largest dimension smaller than the spacing between the bases during the electrochemical reaction, and/or
in response to the electric current, the surface area has a largest dimension creating a nonlinear electric field in the spacing and/or an electric field gradient larger than that produced by planar electrodes.

3. The apparatus of example 1 or 2, further comprising:
one or more of the pairs of the electrodes comprising a first electrode comprising the base comprising a first base and a second electrode comprising the base comprising a second base; and
a mount mounting the first electrode and the second electrode in each of the pairs with the spacing between the first base and the second base, so that the electric current may flow through the fluid between the first base and the second base to drive an electrochemical reaction of the fluid.

4. An apparatus comprising electrodes useful for performing electrolysis, comprising
one or more pairs of non-planar electrodes each comprising a first electrode having a first base and a second electrode comprising a second base,
a mount mounting the first electrode and the second electrode in each of the pairs with a spacing between the first base and the second base, so that an electric current may flow through a fluid between the first base and the second base to drive an electrochemical reaction of the fluid; and
wherein a surface area of the bases (the base of the first electrode and the base of the second electrode) exposed to the fluid are dimensioned to support a current density of the electric current of at least 10 A/cm² or in a range of 10 A/cm² and 14 A/cm².

5. The apparatus of any of the examples 1-4, further comprising:
one or more of the pairs of the electrodes comprising a first electrode comprising the base comprising a first base and a second electrode comprising the base comprising a second base;
a container, comprising a first compartment for containing a first portion of the fluid; and a second compartment for containing a second portion of the fluid;
a non-conductive barrier separating the first compartment from the second compartment, the barrier comprising one or more orifices connecting the first compartment to the second compartment, each of the orifices associated with a different one of the pairs of the electrodes;
one or more first mounts or locators on the first compartment, each of the first mounts associated with locating and/or mounting a different one of the first electrodes in the first portion of the fluid in the first compartment, so that for each one of the pairs of the electrodes, the first base of the first electrode faces the one of orifices associated with the one of the pairs;
one or more second mounts or locators on the second compartment, each of the second mounts associated with locating and/or mounting a different one of the second electrodes in the second portion of the fluid in the second compartment, so that:
for each one of the pairs of the electrodes, the second base of the second electrode faces towards the first base of the first electrode and the one of the orifices associated with the one of the pairs, and
the electric current may flow through the fluid and the one of the orifices between the first base and the second base to drive the electrochemical reaction of the fluid outputting a first gaseous product at the first base and a second gaseous product at the second base;
a first inlet in the first compartment positioned to discharge the first portion of fluid towards the first base, thereby replenishing the first portion of fluid during the electrochemical reaction;
a second inlet in the second compartment positioned to discharge the second portion of fluid towards the second base, thereby replenishing the second portion of fluid during the electrochemical reaction;
a first drain in the first compartment for collecting a first portion of a solid byproduct of the electrochemical reaction;
a second drain in the second compartment for collecting a second portion of the solid byproduct of the electrochemical reaction;
a first outlet in the first compartment for collecting the first gaseous product of the electrochemical reaction evolved at the first base; and
a second outlet in the second compartment for collecting the second gaseous product of the electrochemical reaction evolved at the second base.

6. The apparatus of example 5, wherein:
the container comprises a first sidewall and a second sidewall separated from the first sidewall by a depth dimensioned such that the depth determines a gap between the first base and the second base in each of the pairs of the electrodes when the mount mounts:
the first base of the first electrode is flush and/or aligned with the first sidewall, and
the second base of the second electrode flush and/or aligned with the second sidewall, and
each of the first mounts comprise a first opening dimensioned to expose the first base to the fluid; and
each of the second mounts comprise a second opening dimensioned to expose the second base to the fluid.

7 The apparatus of example 5 or 6, wherein the one or more first mounts comprise one or more first openings into which the first electrodes can move along their longitudinal axis so as to be exposed to the fluid and the one or more second mounts comprise second openings into which the second electrodes can move along their longitudinal axis so as to be exposed to the fluid.

8. The apparatus of example 7, further comprising:
a first electrode dispenser positioned to insert the first electrodes through the first openings into the first compartment when at least driving the electrochemical reaction or removing the first electrode once the first electrode is spent by the electrochemical reaction; and
a second electrode dispenser positioned to insert the second electrodes through the second openings into the first compartment when at least driving the electrochemical reaction or removing the second electrode once the second electrode is spent by the electrochemical reaction.

9 The system of example 8, wherein the first electrode dispenser and the second electrode dispenser each comprise at least one of:
an actuator that automatically advances a length of the electrode into the first compartment or the second compartment; or
a magazine for dropping in a new electrode as needed.

10. The apparatus of example 9, wherein the actuator is configured to control a distance between the first base and the second base during the electrochemical reaction.

11. The apparatus of any of the examples 1-10, further comprising:
one or more control circuits controlling at least one of:
a distance between a first electrode and a second electrode in response to a feedback comprising a measurement of electric current between the first electrode and the second electrode, so that the distance maintains a desired current density of the electric current driving an electrochemical reaction of a fluid in contact with the electrodes, or a static distance between the first base and the second base;
replacement of the electrodes spent by the electrochemical reaction so as to maintain a desired reaction rate of the electrochemical reaction;
reversal of a polarity of the electric current when certain electrode consumption or cleanliness thresholds are met, so as to allow swapping of the first electrode and the second electrode for keeping the electrodes clean and evenly consuming the first electrode and the second electrode; or manifolding of gaseous products outputted from the electrochemical reaction.

12. The apparatus of any of the examples 4-11, wherein:
the first outlet is at the top of the first compartment above the first electrode to collect the first gaseous product evolving upwards,
the second outlet is at the top of the second compartment above the second electrode to collect the second gaseous product evolving upwards,
the first inlet is at the base of the first compartment and comprises a first nozzle or conduit propelling a jet of the seawater towards the first base,
the second inlet is at the base of the second compartment and comprises a second nozzle or conduit propelling a jet of the seawater towards the second base,
the first drain is in the base of the first compartment, and
the second drain is in the base of the second compartment.

13. The apparatus of any of the examples 4-12, wherein the non-conductive barrier comprises a semipermeable membrane covering the orifices.

14. The apparatus of any of the examples 1-13, further comprising:
a container containing the fluid; and
a driving circuit supplying the electric current flowing between the first electrode and the second electrode when:
the driving circuit is connected to the electrodes mounted in the container,
the fluid comprises seawater or an electrolyte comprising a salt and water,
the electrochemical reaction comprises electrolysis,
the electrolysis outputs a first product, comprising hydrogen, at the first base, and
the electrolysis outputs a second product, comprising oxygen, at the second base, and wherein:
the driving circuit comprises a setting outputting the electric current at a level wherein output of chlorine, from the salt in the fluid at the first or second electrode comprising the anode, is suppressed below a target level comprising a negligible level or non-toxic level.

15. The apparatus of any of the examples 1-14, further comprising a sensor connected to the container for sensing at least one of the hydrogen or carbon dioxide.

16. The apparatus of any of the examples 1-15, further comprising a mount
mounting one or more pairs of the electrodes, comprising a first electrode
comprising the base comprising a first base and the second electrode
comprising the base comprising a second base, with the spacing between
the first base and the second base in a range of 0.5 cm-3 cm.

17. The apparatus of any of the examples 1-16, wherein the electrodes have a diameter in a range of 0.5 mm-10 mm and the length in a range of 0.5 cm-2 cm.

18. The apparatus of any of the examples 1-17, wherein:
the electrodes comprise an electrochemically active material having electrode sidewalls and a coating on the electrode sidewalls but not on the base, and
the coating comprises an electrochemically inactive material that does not participate in the electrochemical reaction.

19. The apparatus of example 18, wherein:
the electrodes each have a longitudinal axis, and
the coating has a thickness that collapses as the electrochemically active material is consumed and recedes along a direction of the longitudinal axis during the electrochemical reaction, so as to maintain a constant effective area of the base exposed to the fluid during the electrochemical reaction.

20. The apparatus of example 18 or 19, wherein the coating is deposited by chemical vapor deposition or physical vapor deposition.

21. The apparatus of any of the examples 18-20, wherein the coating comprises at least one of a metal oxide, a metal nitride, a metal fluoride, or a compound thereof.

22. The apparatus of any of the examples 18-21, wherein the electrochemically active material comprises, consists of, or consists essentially of metal, carbon, graphite, graphene, one or more rolled graphene sheets, or carbon nanotubes.

23. The apparatus of any of the examples 1-22, further comprising an array comprising a plurality of the pairs of the electrodes, wherein:
the array comprises a 1 dimensional array of the electrodes comprising the first electrodes in the pairs disposed along a first line and the second electrodes in the pairs disposed along a second line, or
a two dimensional array of the electrodes, comprising:
the first electrodes disposed in a repeating pattern or lattice of a first unit cell defined by a first spacing in a first direction and a second spacing in a second direction; and
the second electrodes disposed in a repeating pattern or lattice of a second unit cell defined by the first spacing in the first direction direction and a second spacing in a second direction.

24. The apparatus of any of the examples 1-23, further comprising:
one or more of the pairs of the electrodes comprising a first electrode and a second electrode,
the first electrode comprising a first longitudinal axis,
the second electrode comprising a second longitudinal axis, and
a mount aligning the first electrode and the second electrode in each pair such that the first longitudinal axis and the second longitudinal axis are colinear or along a line of sight.

25. The apparatus of any of the examples 1-24, further comprising:
one or more of the pairs of the electrodes comprising a first electrode and a second electrode, the first electrode comprising a first longitudinal axis, and the second electrode comprising a second longitudinal axis, and
a mount mounting the first electrode and the second electrode in each pair with an offset such that the first longitudinal axis and the second longitudinal axis are offset in a direction perpendicular to the longitudinal axes.

26. The apparatus of any of the examples 1-25, wherein the pairs of the electrodes comprise a first electrode and the second electrode comprising at least one of:
different lengths, or
different widths, or
a taper or a width that varies along a length of the first electrode or the second electrode.

27. The apparatus of any of the examples 1-26, wherein the electrodes each comprise at least one of:
a cylinder, a tube, a rod, or a polyhedron having a cross section comprising a polygon or circle and the first base and the second base each comprise a base of the cylinder, the tube, the rod, or the polyhedron, or
symmetry about the longitudinal axis of the electrodes.

28. A method of performing an electrochemical reaction, comprising:
contacting a fluid with one or more pairs of non-planar electrodes each comprising a first electrode having a first base and a second electrode comprising a second base,
applying a voltage difference between the first electrode and the second electrode in each of the pairs so that an electric current flows through the fluid between the first base and the second base, wherein:
the electric current drives an electrochemical reaction of the fluid; and
a surface area of the bases (the base of the first electrode and the base of the second electrode) exposed to the fluid are dimensioned to support a current density of the electric current of at least 10 A/cm² or in a range of 10 A/cm² and 14 A/cm².

29. The method of example 28, wherein:
the fluid comprises seawater or a liquid comprising salt,
the electrochemical reaction comprises electrolysis,
the electrolysis outputs a first product, comprising hydrogen, at the first base, and
the electrolysis outputs a second product, comprising oxygen, at the second base, and the method further comprising:
increasing the electric current to a level wherein output of chlorine, from the salt in the fluid at the first or second electrode comprising the anode, is suppressed below a target level comprising a negligible level or non-toxic level.

The present disclosure further presents results on the experimental production of clean hydrogen fuel via electrolysis of natural seawater, demonstrating that an example utilizes cost-effective and easily replenishable electrodes that are capable of safely sustaining a current density much higher than previously deemed practical while avoiding concurrent generation of toxic chlorine gas and allowing reclamation of byproducts formed during the electrolysis process.

### BRIEF DESCRIPTION OF THE DRAWINGS

Referring now to the drawings in which like reference numbers represent corresponding parts throughout:

FIG. 1: (a) A perspective view of a conventional electrolysis system that consists of a pair of planar electrodes immersed in electrolyte. (b) Top view of the planar electrodes

FIG. 2: System Diagram: The electrodes (1) & (2) are immersed in seawater within a covered concrete tank having two compartments that are separated by a bulkhead with an in-line orifice (3) through which the circuit is established. In embodiments, this orifice can be partially restricted using a semipermeable material that allows the passage of ions. Examples of such materials include glass fiber mat, Nafion membrane, or any other semipermeable material that allows the passage of ions. The current is maintained constant via an automated mechanism (9) for controlling the distance between the electrode's exposed faces as they are consumed. When the electrodes have significantly eroded away, magazines (8) feed—in replacements for uninterrupted operation. Cathodic (6) and anodic (7) gases are vented/collected at the top, while the active electrode faces are provided with fresh seawater via jets (4). Generated solid byproduct is collected through the suctioning drains (5) for reprocessing and reclamation.

FIG. 3: Schematic of the electrodes and electrode dispenser. The rod-shaped electrodes made of an inexpensive graphite (drawn in gray in this Figure) are consumed at relatively constant rates during the electrolysis process. The outside of the electrode is covered with a protective layer (e.g., aluminum oxide, silicon dioxide, or any other appropriate insulating, electrically neutral dielectric compound that can be used as a coating) that does not participate in the electrolysis. As shown in (a), the protective layer is thin enough so that it cannot mechanically support itself as the electrode material beneath it recedes. Preferably, this protective layer collapses in synchronization with the consumption of the electrode material, thus maintaining constant the effective area exposed to the electrolyte and facilitating stabilized current density over time. In (b), the consumed portion of the electrode is replenished from outside the chamber via a mechanism that automatically advances its length (b9); followed, as needed, by dropping in a new electrode from the magazine (b8).

FIG. 4: Schematic of gas separation and by-product collection system. For safety and efficiency, the system has a non-conductive bulkhead separating the two halves of the tank. This bulkhead is provided with an orifice (3), in-line with the horizontal electrode faces, through which the circuit is established. The cathodic (H₂) and anodic gases (mainly (2) stream up into the separate gas spaces above the surface of the electrolyte, where they are drawn off. Raw seawater is pumped through jets (4) pointed at the active electrode faces in order to avoid ionic depletion and move evolving gases away from the orifice in the centerline barrier. Automatically-controlled suction drains (5) maintain constant liquid level within the compartments, as well as for removal of solid byproducts of the electrochemical reactions.

FIG. 5. Seawater electrolysis setup comprising a DC power supply (dialed—in voltage); a digital multimeter (reading amperage); a seawater filled reaction chamber (with sleeved 2 mm diameter graphite rod electrodes) on an elevated magnetic stirrer; tube conveying evolved gases (terminating in upward-pointing hypodermic needle); and an inverted gas collection vial filled with MilliQ water (screw cap with self-sealing disc) placed into ice bath.

FIG. 6 Photograph illustrating the two ends of the apparatus for capturing gases during high-current density seawater electrolysis using the electrolyzer in FIG. 6. Between the two ends is a length of 5/16″ID Nalgene 180 PVC tubing (VI Grade) that carries the evolved gases from the reaction chamber to the evolved gases collection vial.

FIG. 7: Panel (a): a perspective view of one embodiment of the invention, that is, an electrolysis system that consists of a pair of rod-shaped (or 3-dimensional) electrodes immersed in electrolyte. Panel (b) is the cross-sectional view showing the width of the electrodes.

FIG. 8: Finite-element analysis of a two-dimensional representation of a conventional electrolysis system comprising the pair of 2 cm wide planar electrodes illustrated in FIG. 1. The calculation used an electrical potential VA=104.8 V applied to the anode while the cathode is grounded to obtain Jc=1 A/cm². Panel (a): a contour map of the x-component of electric field Ex overlaid with a color map of electrical potential V. Panel (b): a color map of Ex. The magnitude and distribution of Ex suggest that the highest magnitude of Ex is localized at the four corners of the electrodes. Ex along the dotted black line in panel (b) is nearly uniform across the gap. The scale bars represent 1 cm.

FIG. 9: Finite-element analysis of a two-dimensional representation of an embodiment of the invention comprising the single pair of 2 mm wide rod electrodes illustrated in FIG. 2 (in contrast to a pair of planar electrodes in FIG. 1). The calculation used an electrical potential VA=34 V applied to the anode while the cathode was grounded to obtain Jc=12 A/cm². Panel (a): a contour map of the x-component of electric field Ex overlaid with a color map of electrical potential V. Panel (b): a color map of Ex. The magnitude and distribution of Ex suggest that a gradient of Ex is established along the black dotted line in panel (b). The scale bars represent 1 cm.

FIG. 10: Finite-element analysis of a two-dimensional representation of an embodiment of the invention with 4 pairs (N=4) of 2 mm wide rod electrodes placed in the line-of-sight. The number of pairs N-4 is not a limitation and is merely provided as an example. The calculation used an electrical potential VA=47.3 V applied to the anodes while the cathodes were grounded to obtain Jc=12 A/cm². Panel (a) a contour map of Ex overlaid with a color map of electrical potential V. Panel (b): a color map of Ex. The magnitude and distribution of Ex suggest that a gradient in Ex is established across the gap along the black dotted line in Panel (b) and Ex is stronger near the electrodes, which is expected to occur for all the electrodes in the line-of-sight. A gradient of Ex is also established for the second and the third nearest neighboring electrodes. The scale bars represent 1 cm.

FIG. 11: Finite-element analysis of a two-dimensional representation of an embodiment of the invention with 4 pairs (N=4) of 2 mm wide rod electrodes placed with an offset. In contrast to FIG. 10, the electrodes are placed with a constant off-set perpendicular to the x-direction. The calculation uses an electrical potential VA=48.8 V applied to the anodes while the cathodes are grounded to obtain Jc=12 A/cm². Panel (a): a contour map of Ex overlaid with a color map of electrical potential V. Panel (b): a color map of Ex. The magnitude and distribution of Ex suggest that a gradient of Ex is established along the black dotted line in Panel (b) and Ex is stronger near the electrodes. A gradient of Ex is also established for the second and the third nearest neighboring electrodes. The scale bars represent 1 cm.

FIG. 12. Schematic (looking along the lengths of the electrodes) showing an example arrangement of multiple rod-shaped electrodes placed on the x-y plane of the support structures.

FIG. 13: Top (plan), side (elevation), or cross-sectional view schematic of an example wherein one of the electrodes in the pair of electrodes is longer than the other.

FIG. 14. Top/plan, side/elevation, or cross-sectional view schematic of an example wherein one of the electrodes in the pair of electrodes is placed with an offset with respect to the other.

FIG. 15: Top/plan, side/elevation, or cross-sectional schematic view of an example wherein one electrode in the pair of electrodes has larger size than the other.

FIG. 16. Top/plan, side/elevation, or cross-sectional schematic view of an example wherein the electrodes have diameter that varies along the lengths of the electrodes.

FIG. 17. Schematic perspective view of electrolyzer utilizing an array of electrodes.

FIG. 18. Schematic side view of the electrolyzer of FIG. 17.

FIG. 19—System for continuous application of Jc larger than 1 A cm⁻² and collection of evolved gases during seawater electrolysis and using the electrolyzer/reaction vessel or chamber of FIG. 2.

FIG. 20: Chlorine concentration evolved using the apparatus of FIG. 2 to perform electrolysis of seawater: a) Electrical resistance R and electrical power P plotted as a function of Jc. P increased exponentially, while R declined exponentially as Jc increased from 1 A/cm² and tends to saturate after Jc reaches ˜10 A/cm². (b) the dependence of the relative chlorine concentration [Cl] on Jc. [Cl] increases rapidly as Jc exceeds ˜6 A/cm². Subsequently, [Cl] reaches its maximum of ˜0.52 at around Jc ˜8 A/cm², and then it promptly decreases to the level in the range of 0.05˜0.06 comparable to those at Jc smaller than ˜6 A/cm², and [Cl] appears to remain below 0.05 for further increases in Jc. The highest chlorine concentration occurs around about 7.5 A/cm² with an input voltage of 30 V. The lowest chlorine production observed occurred at about 13 A/cm² at an input voltage of 55 V. The system becomes unstable at an input voltage of about 90 V or higher. Therefore, the lowest stable chlorine production occurs between about 12 A/cm² and about 14 A/cm² or between 50 and 60 volts.

FIG. 21—The two-dimensional geometrical domain, l_{c}=10 cm long and w_{c}=4 cm wide, used inn the FE modeling. For consistency with materials used in the experiment, the FE modeing domain includes a pair of graphite electrodes covered by electrically insulating SiO₂. The white area represents seawater. Number 1-8 are specify locations of pairs of points defining line segments used in Table 1. Each line segment (e.g., 1-2) assigns a specific boundary condition in the FE modeling. Modeling was done in two-dimensions, rather than three, without losing any general principles since the electrodes are rods with circular cross-sections placed symmetrically about a vertical plane rising from the domain's center line (shown as the dot-dash line in FIG. 3 and used later in FIGS. 4 and 5). For consistency with materials used in the experiment, the modeling domain includes a pair of rod-shaped graphite

FIG. 22-Color maps of the magnitude and distribution of the electric field in the seawater between the electrodes, parallel to the x-direction Ex for (a) wₑ=0.2 cm and (c) wₑ=2 cm. (b) and (c) are contour maps of Ex isopleths overlaid on VA color maps for (b) wₑ=0.2 and (d) wₑ=2 cm. In all panels, graphite and SiO₂ are colored black and yellow, respectively. Scale bars are 1 cm. (For interpretation of the references to color/colour in this figure legend, the reader is referred to the Web version of this article.)

FIG. 23-Maximum Eₓ(Eₘₐₓ), minimum Eₓ(Eₘᵢₙ), and the difference ΔE between them (Eₘₐₓ-Eₘᵢₙ) along the centerline between the two electrodes as functions of electrode width wₑ.

FIG. 24. Flowchart illustrating a method of making electrodes.

FIG. 25. Flowchart illustrating a method of making a system for performing an electrochemical reaction.

FIG. 26. Flowchart illustrating a method of making a reaction vessel for the electrochemical reaction.

FIG. 27. Flowchart illustrating a method of performing an electrochemical reaction.

FIG. 28. Example Hardware environment for controlling a reactor or electrochemical reaction.

FIG. 29. Example Network environment for controlling the reactor or electrochemical reaction.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

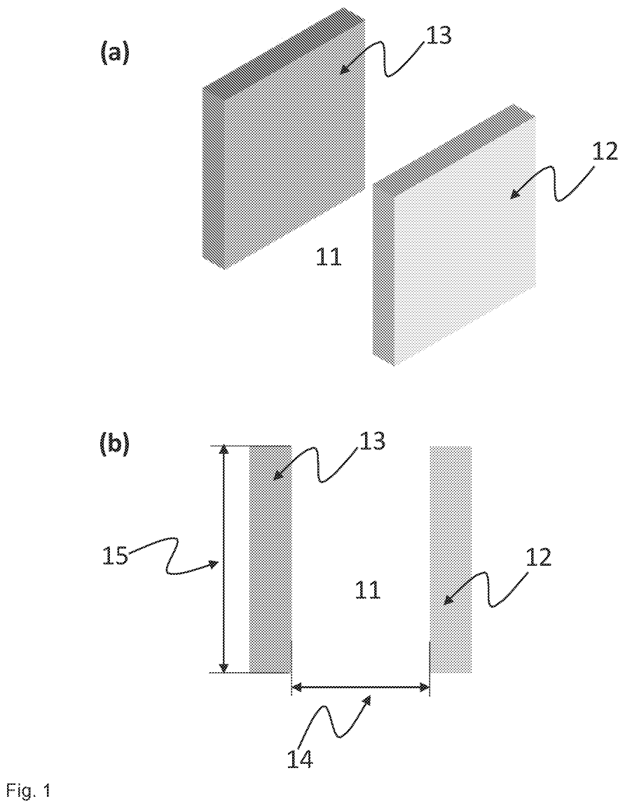

FIG. 1 illustrates a conventional electrolysis system that consists of a pair of planar electrodes immersed in electrolyte (11). The anode (13) and the cathode (12) electrodes are separated by a gap (14). Electrical potential VA is applied to the anode while the cathode is grounded during electrolysis to provide an electrical current density Jc ˜1 A/cm², resulting in negligible electric potential gradient Efield between the electrodes, small rates of hydrogen production, and substantial chlorine evolution. What is needed then, are technologies that produce hydrogen at higher rates (i.e., an economic incentive) without generating toxic byproducts (i.e., an environmental incentive). The present disclosure satisfies this need.

The present disclosure describes an electrolysis system and configuration of electrodes that can, in some embodiments, enable the following distinctive features.

(1) The use of Jc (e.g., Jc>10 A/cm²) much larger than that (Jc ˜1 A/cm²) typically used in conventional electrolysis systems. The use of Jc>10 A/cm² is a critical feature that significantly suppresses CER and substantially increases the hydrogen production rate.

(2) The use of rod-shaped or 3-dimensional (non-planar) micro-electrodes with diameter of at least ˜5×10⁻³ m, in contrast to planar electrodes used in conventional electrolysis systems. In one embodiment, a pair of rod-shaped micro-electrodes are placed face-to-face, restricting the conduction path through which electrical current flows and allowing the safe and continuous application of Jc>10 A/cm². The rod-shaped micro-electrodes are made of materials such as (but not limited to) graphite or metal(s) that are machinable, inexpensive, and abundant, significantly reducing material and manufacturing costs as compared to electrodes that employ costly catalytic chemical elements (CCEs) in conventional electrolysis systems.

(3) The use of an array of rod-shaped micro-electrodes, in contrast to a pair of planar electrodes covered with expensive CCEs as used in conventional electrolysis systems. An array of rod-shaped micro-electrodes establishes a strong electric-field and desirable electric-field distribution that efficiently transports ions participating in electrolysis of seawater (EOS), reducing acidity in the vicinity of the anode and suppressing CER.

The present disclosure further reports on results achieved for an apparatus performing seawater electrolysis achieving high current densities by direct application of strong electric power using a very tough, earth-abundant electrode material that ranks highest (or has a high ranking) in the Galvanic series (e.g., graphite, for best survivability in the extremely corrosive local environment of the anode). Other electrode materials could include graphene, carbon nanotubes, or other carbon structures.

### First Example: Electrolyzer System

a. Reaction Vessel and Electrode Mounting

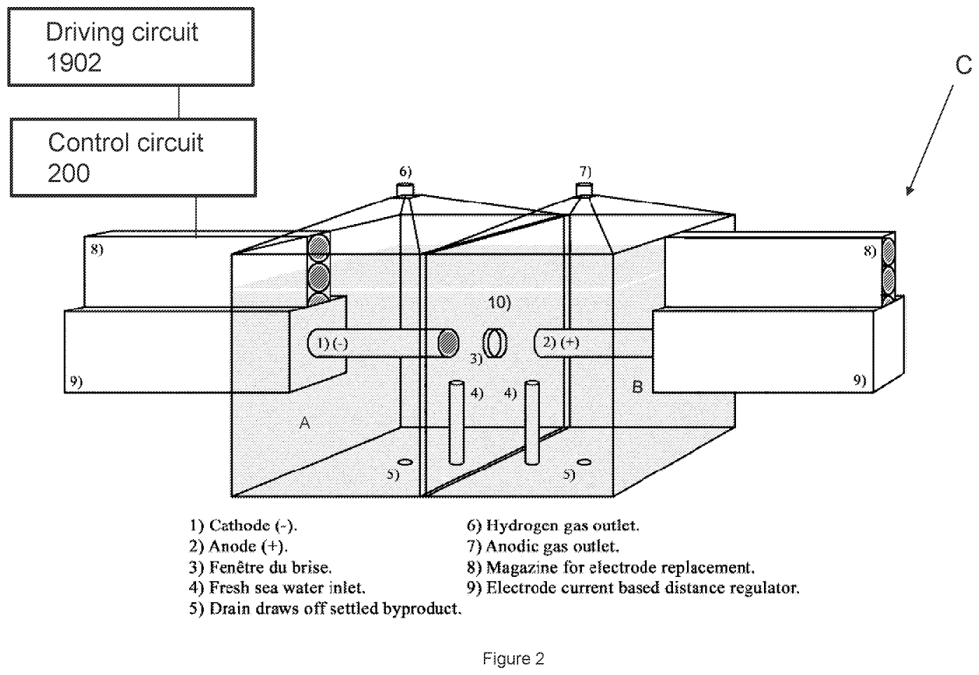

FIG. 2 illustrates an example electrolyzer comprising a first compartment A for containing a first portion of a fluid (e.g., electrolyte); a second compartment B for containing a second portion of the fluid; and a non-conductive barrier (10) separating the first compartment from the second compartment, the barrier comprising a single orifice (3) connecting the first compartment to the second compartment.

The first compartment further comprises a first opening through which a first electrode (1) is inserted into the first portion of the fluid in the first compartment, so that a first end of the first electrode points towards the single orifice. The second compartment further comprises a second opening through which a second electrode (2) is inserted into the second portion of the fluid in the second compartment.

As illustrated in FIG. 2, the second end of the second electrode points towards the single orifice and faces the first end, so that an electric current may flow through the fluid and the single orifice between the first end and the second end to drive an electrochemical reaction of the fluid outputting a first gaseous product at the first end and a second gaseous product at the second end. FIG. 5 illustrates a driving circuit connected to the electrodes for supplying the electric current flowing between the first electrode and the second electrode.

FIG. 2 further illustrates a first inlet (4) in the first compartment positioned to discharge the first portion of fluid towards the first end, enabling replenishment of the first portion of fluid during the electrochemical reaction. The electrolyzer further comprises a second inlet (4) in the second compartment positioned to discharge the second portion of fluid towards the second end, enabling replenishment of the second portion of fluid during the electrochemical reaction.

As illustrated in FIG. 2, the electrolyzer further comprises a first drain (5) in the first compartment for collecting a first portion of a solid byproduct of the electrochemical reaction; a second drain (5) in the second compartment for collecting a second portion of the solid byproduct of the electrochemical reaction; a first outlet (6) in the first compartment for collecting the first gaseous product of the electrochemical reaction evolved at the first end of the first electrode; and a second outlet (7) in the second compartment for collecting the second gaseous product of the electrochemical reaction evolved at the second end of the second electrode.

In the embodiment illustrated in FIG. 2, the electrolyzer further comprise a first electrode dispenser (8) and a second electrode dispenser (8). The first electrode dispenser and the second dispenser are positioned to insert the first electrode into the first compartment, and second electrode into the second compartment, respectively, for driving the electrochemical reaction. The first dispenser (the second dispenser) may also remove or replace the first electrode (second electrode) spent by the electrochemical reaction.

In one or more embodiments, the system operates at ambient temperature and pressure, and can be powered by long-term low-cost renewable electricity (e.g., solar or wind farm), and conducted in either large covered shoreside tanks or in open sea facilities. This non-polluting apparatus can be engineered and upscaled to an industrial scale.

Further details of various aspects of the present invention are further discussed in the following sections.

b. Example Control System that Maintains System Operation

FIG. 2 illustrates a control system for controlling the electrochemical reaction (i.e., electrolysis). The control system includes (a) a current based feedback system that maintains an ideal current density by adjusting the distance between the electrodes; and (b) a magazine that holds several ready electrodes that are seamlessly fed in via the control system for uninterrupted production. The system further provides for (c) reversal of the reaction when certain electrode thresholds are met to allow swapping of the anode and cathode, so as to keep the electrodes clean and share the higher consumption rate of the anode; and (d) automated manifolding of the gaseous products).

c. Example Electrode Coatings and Materials

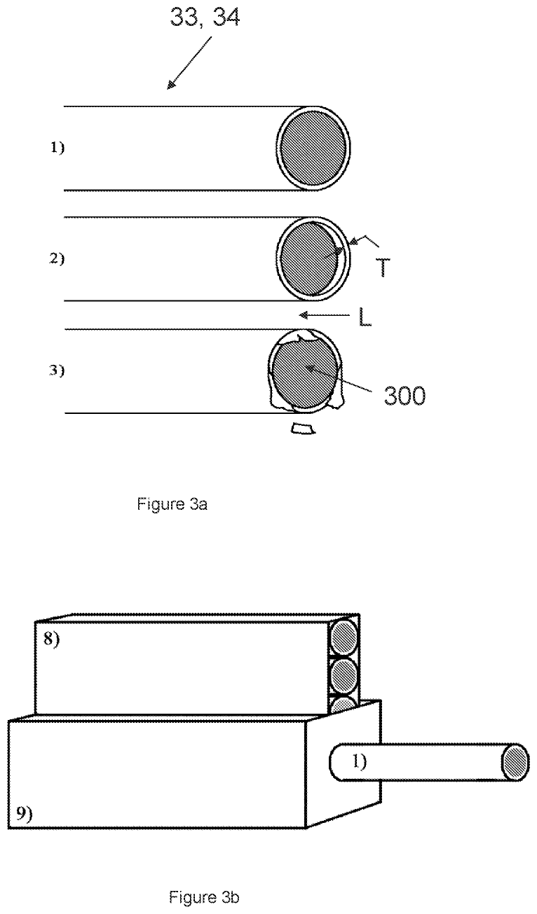

FIG. 3 illustrates the electrodes may be coated with a non-conductive material that does not participate in the electrolysis reaction (e.g., aluminum oxide). In one or more embodiments, the coating is deposited through atomic layer deposition (ALD) or other process. In further examples, the coating ideally ablates as the electrodes are consumed, allowing the active areas of the electrodes to remain exposed and resist entrapment of bubbles against the active area as such bubbles may diminish the effectiveness of the electrolysis.

A variety of electrodes and electrode configurations may be used. Example electrodes include, but are not limited to, large rods of graphite electrodes such as those used in electric arc furnaces (up to 750 mm diameter and 3 m in length). Other carbon electrodes may be used such as, but not limited to, electrodes comprising graphene (including rolled graphene sheets) and/or carbon nanotubes (e.g., that have higher conductivity than standard graphite). In other examples, the electrodes comprise an array comprising more than one electrode.

d. Example Gas Separation and by-Product Collection System

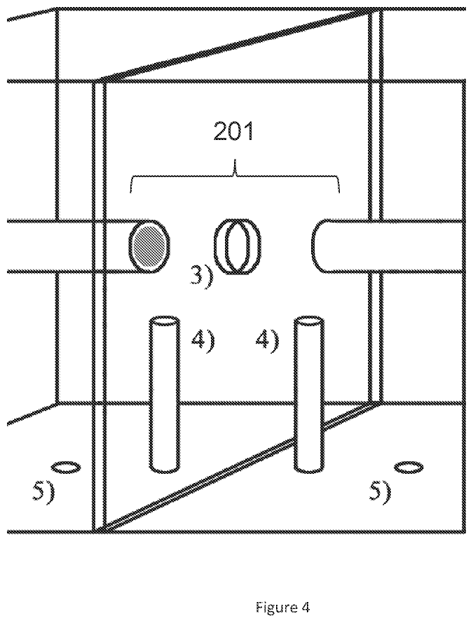

FIG. 4 illustrates an example system for (a) safely and separately collecting the cathodic (H₂) and anodic (mainly O₂) gases by use of a non-conductive barrier having a single orifice through which the circuit is established; (b) constantly refreshing the reaction sites with significant amounts of raw seawater electrolyte and so as to propel produced gases upwards and away from the orifice; and (d) capturing solid byproducts for recycling and/or reuse. The orifice can be covered with a semipermeable material as described above.

### Second Example: Electrode Configurations

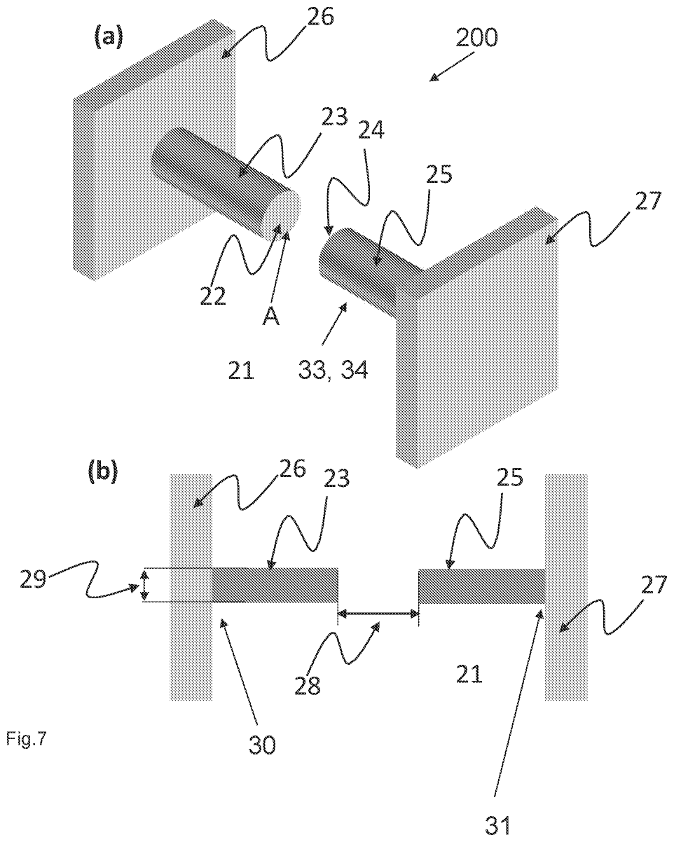

FIG. 7 illustrates an example electrode configuration comprising a pair of rod-shaped electrodes immersed in electrolyte (21). The anode (23) and the cathode (22) are placed in the line of sight and separated by a gap (28). Side walls of the anode (23) and the cathode (25) are electrically insulated (i.e., they are electrochemically inactive) while their cross-sections (22) and (24) are electrochemically active. The width of the electrodes is represented in the cross-sectional view by a dimensional length (29) (2 mm in the embodiment measured for the results in FIG. 9), but the electrode itself is three dimensional. Electrical potential VA is applied to the anode while the cathode is grounded during electrolysis. The anode and the cathode are mechanically supported by components (26) and (27).

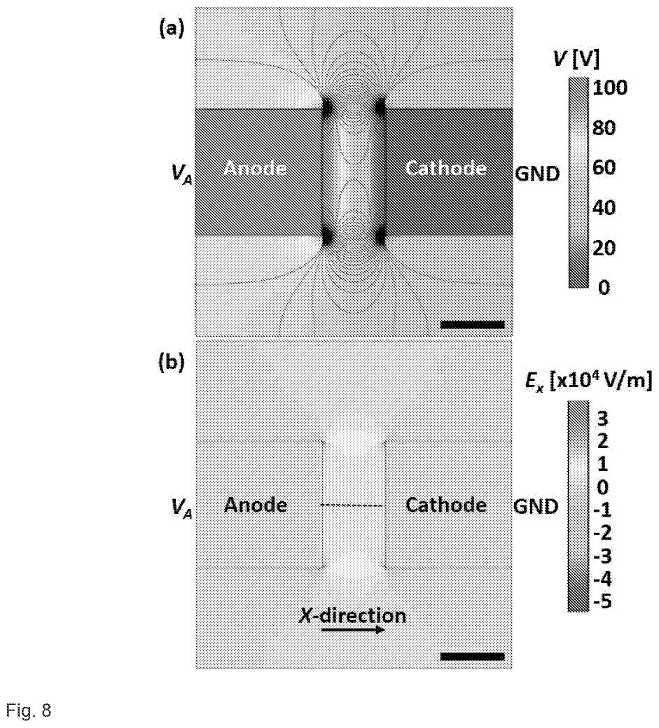

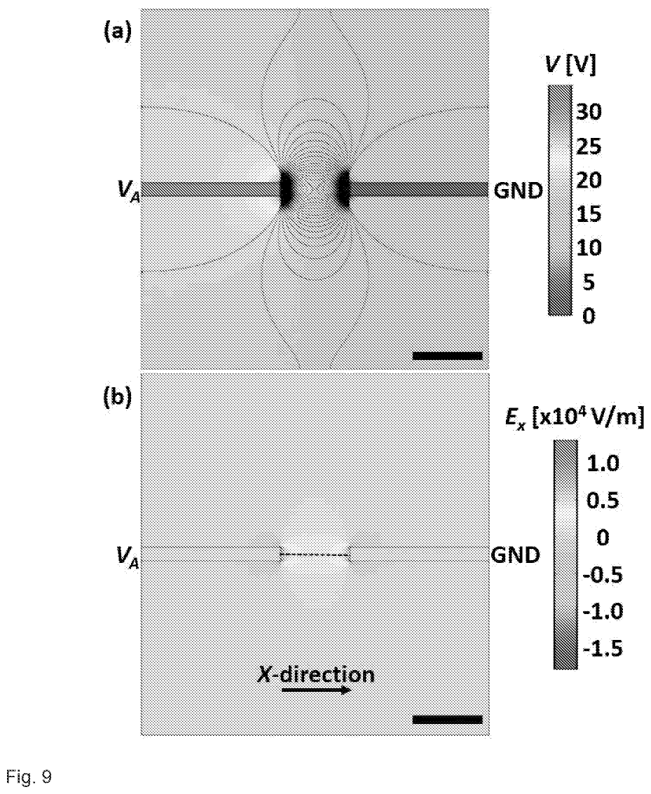

FIG. 9 plots the results of a finite-element calculation of the electric field distribution for the electrode configuration of FIG. 7 having the electrode width (29) of 2 mm. Electrical potential VA=34 V is applied to the anode while the cathode is grounded to obtain Jc=12 A/cm², significantly higher than the Jc=1 A/cm² (see FIG. 8) obtained by applying a significantly higher electrical potential VA=104.8 V to the electrode configuration of FIG. 1.

a. Array Embodiment

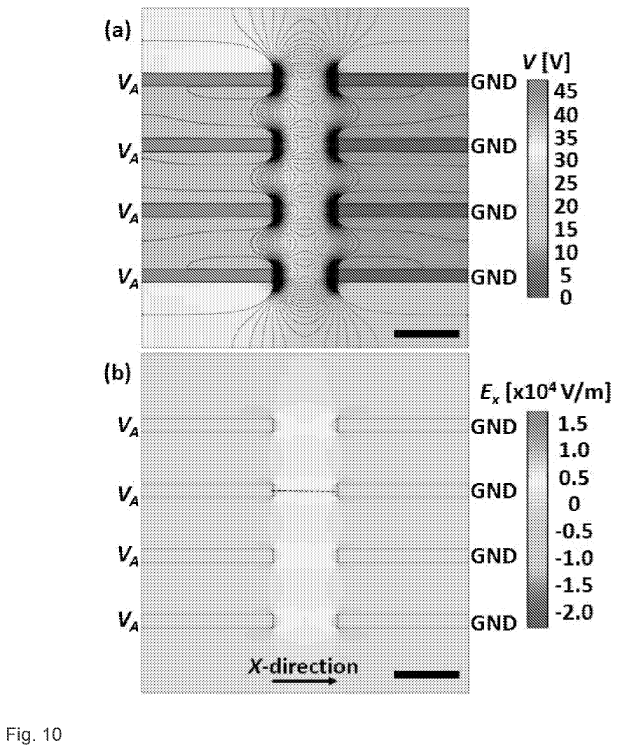

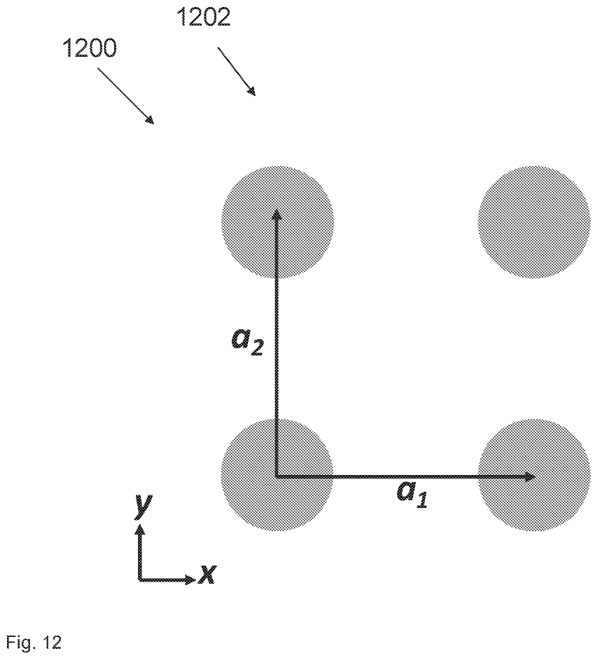

FIG. 12 illustrates an embodiment comprising multiple rod-shaped electrodes placed on the x-y plane of the components (26) and (27) in FIG. 7. In this example, the number of electrodes Nis 4, although N can be any positive integer larger than 1. The arrangement is characterized by two characteristic vectors a1 and a2. The magnitude of the two vectors and the angle between the two vectors can be arbitrarily chosen. FIG. 10 shows the electric field calculated by finite-element analysis for the configuration of FIG. 12 wherein the cathode and the electrode are aligned along a line of sight.

b. Variable Dimension and Alignment Examples

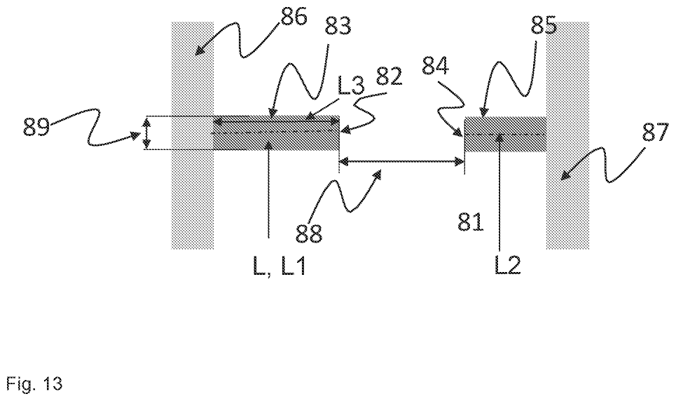

FIG. 13 illustrates an example embodiment wherein one of the electrodes in the pair of electrodes is longer than the other (85). The two electrodes are separated by a gap (88) and the width of the electrodes is represented by the length (89). FIG. 13 further illustrates an embodiment wherein the side walls of the electrodes are insulated (i.e., electrochemically inactive) while the two ends (82) and (84) of the electrode exposed to electrolyte (81) are electrochemically active. The anode and the cathode are mechanically supported by components (86) and (87) when the electrodes are immersed in electrolyte (81).

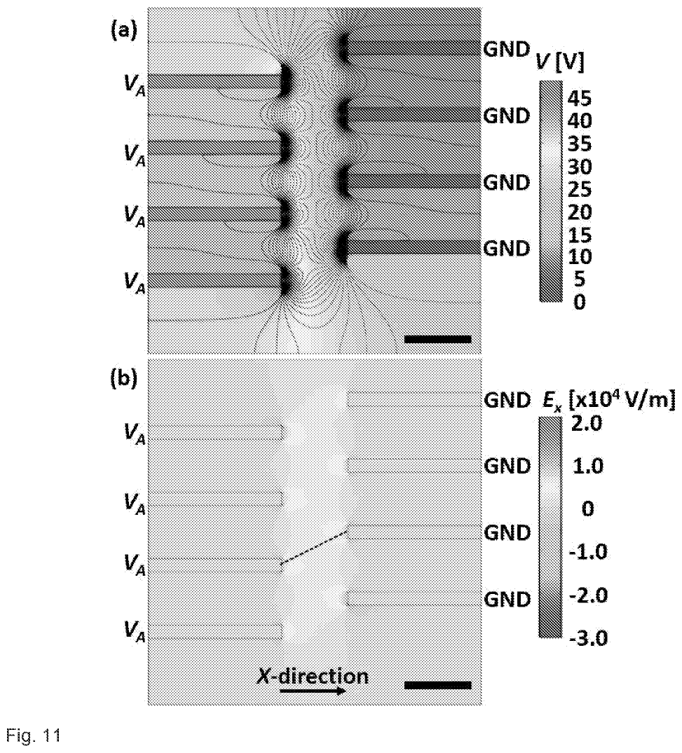

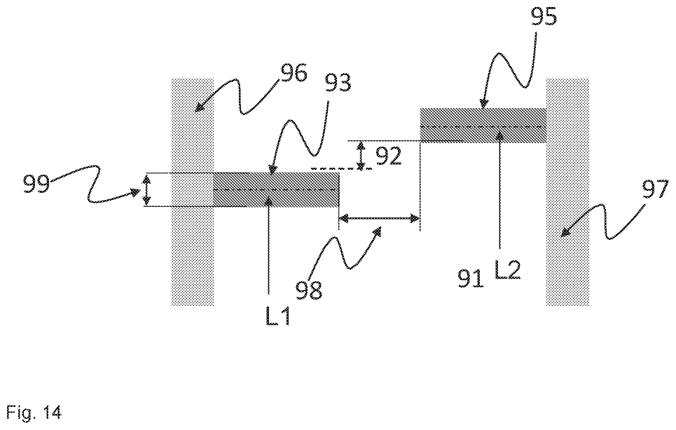

FIG. 14 illustrates an example wherein one of the pair of electrodes is placed with an offset (92) with respect to the other. The two electrodes are separated by a gap (98) and the width of the electrodes is represented by the length (99). The anode and the cathode are mechanically supported by components (96) and (97) when the electrodes are immersed in electrolyte (91). FIG. 11 shows a finite element analysis calculation of the electric field for an array embodiment wherein the electrodes in each pair are offset from one another as shown in FIG. 14.

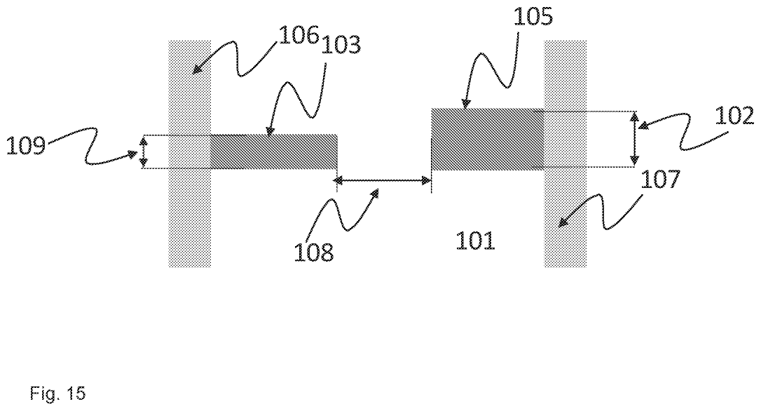

FIG. 15 illustrates an example wherein one (103) of the pair of electrodes has larger size (109) than that (102) of the other (105). As shown in FIG. 15, the two electrodes are separated by a gap (108) and the anode and the cathode are mechanically supported by components (106) and (107) when the electrodes are immersed in electrolyte (101).

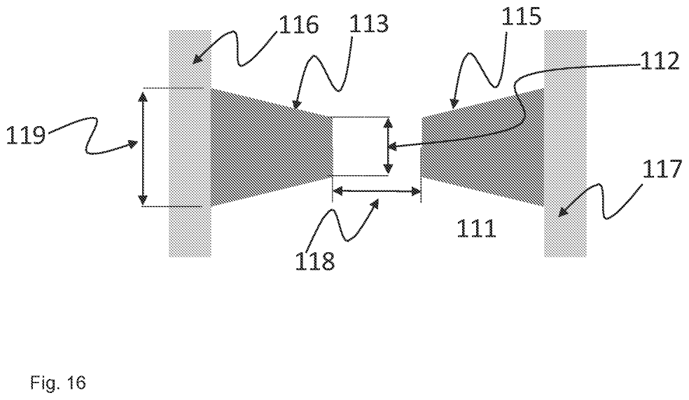

FIG. 16 illustrates an example wherein the electrodes (113) and (115) have a diameter that varies in the range of (119) and (112) along the lengths of the electrodes. As shown in FIG. 16, the two electrodes are separated by a gap (118), and the anode and the cathode are mechanically supported by components (116) and (117) when the electrodes are immersed in electrolyte (111).

### Third Example: Electrolyzer with Array of Electrodes

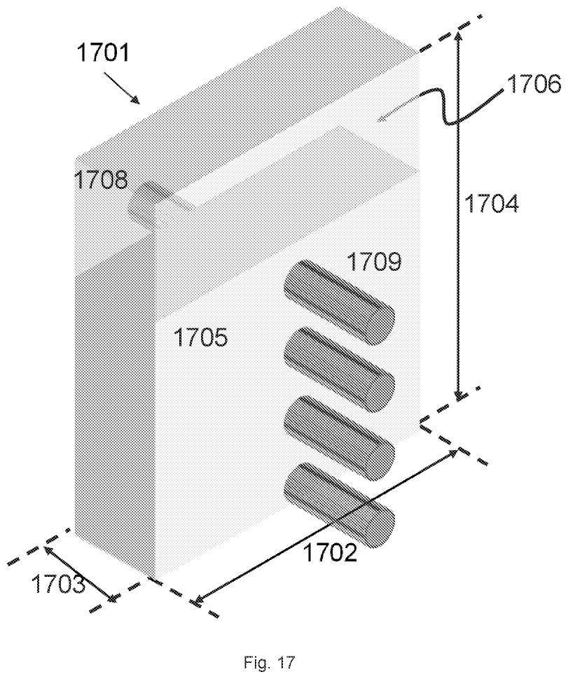

FIGS. 17(a)-(b) illustrate a seawater electrolysis system according to another embodiment. The system comprises a 6-sided box 1701, with inner width 1702, inner depth 1703, and height 1704, filled with electrolyte 1705. The box can leave a head space 1706. The specific shape and dimensions illustrated in FIG. 17 (a) merely provide an example; thus, inner width 1702, inner depth, 1703, and height 1704 and relative ratios between two of the three lengths can be arbitrary.

FIG. 17(b) is a side view (i.e., the view in the direction perpendicular to the depth 1703) of the system that highlights several novel and inventive features of the electrolyzer. The system 1707 comprises a pair of arrayed electrodes 1708 and 1709; an inner barrier 1710 with an array of orifices 1711 in-line with the arrayed electrodes 17708 and 109. Each of the orifices 1711 is fitted with a water-permeable diaphragm/separator of thin glass fiber filter material. In some examples, a pump may be used to constantly circulate electrolyte 1705.

The number of electrode pairs in the array of electrodes 1708 and 1709 of FIG. 17 (b) is merely provided as an example. The number of electrodes in an array can be any number larger than 1. Moreover, the multiple electrodes in the arrays can be arranged in a number of different ways, including but not limited to an n×m array where n=m, n>m, or nem, wherein n and m can be any integers.

FIG. 17 (b) illustrates an embodiment wherein the faces of the electrodes in the arrays 108 and 109 are flush with their respective sidewalls 1712 and 1713 of the box (i.e., with only their cross-sectional faces are exposed to the electrolyte). The electrolyzer is built on a 6-sided box 1701 with inner depth 1703 that defines the distance between a pair of electrodes-electrode gap-1714 depending on inner depth 1703

The electrolyzer of FIG. 17 further provides a static electrode gap—inner depth 1703—that can be maintained even as the anode is consumed by the electrolysis process. The electrode arrays can be embedded into motorized lab bench scissor jacks—perpendicular to the box so as to evenly advance the electrodes—so as to maintain the static electrode gap by measuring and maintaining the initial resistance between the anode(s) and cathode(s).

In one or more embodiments, generation of hydrogen can be measured via reading volumetric gas flow evolved at the cathode, based on the assumption that the only gas generated at the cathode is hydrogen gas. In one or more embodiments, the reaction chamber/electrolyzer can be fitted with a dissolved CO₂ sensor to monitor CO₂ evolution at any point during the high current density electrolysis process.

### Fourth Example: Electrolysis Using the Electrolyzer of the First Example

### Apparatus

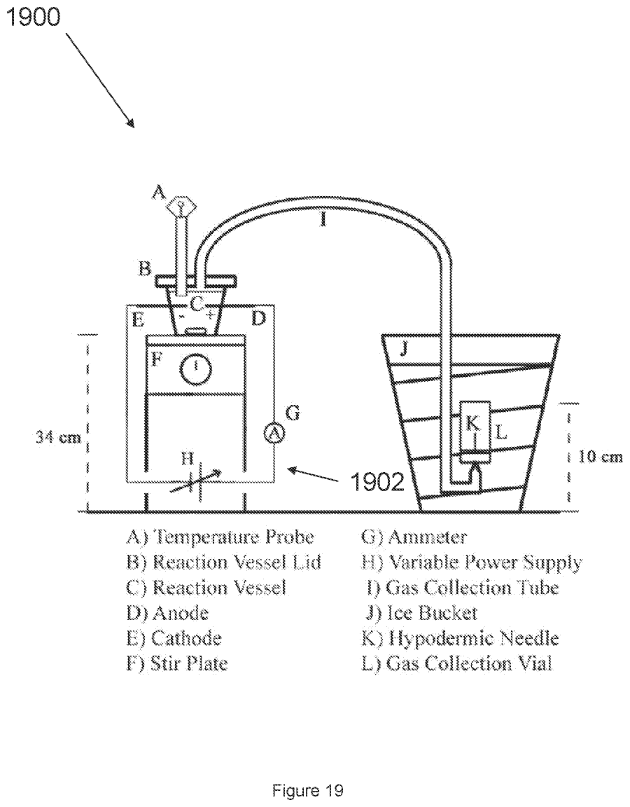

FIG. 19 illustrates an experimental apparatus consists of a reaction vessel (electrolyzer C of FIG. 2) connected to a gas collection system. For the data presented herein, apparatus comprises the following. The reaction vessel (“C”) is a sealed and pressurized 120 ml Kendall polypropylene screw-lid specimen cup (“B”) with a Buna-70 nitrile O-ring gasket (durometer 035, with 0.070″ cross-section and 2 ⅜ O.D.). The screw lid (“B”) is fitted with a digital temperature probe (“A”) and has a central hole attached to the gas collection tube (“I”), a 1.1 m length of 5/16″ I.D. Nalgene 180 PVC tubing (VI Grade) cemented to the lid with E6000 adhesive. The gas collection tube directs a mix of gases, evolved separately at the anode and cathode, to a gas collection vial (“L”) consisting of an inverted 24 ml glass screwcap septum vial, with a self-sealing PTFE/Silicon disc, that is entirely filled with Milli-Q® Type 1 ultrapure water (for its high gas absorption receptivity). The end of the gas collection tube is fitted with a fine hypodermic needle (“K”) from an EXELINT U-100 0.5ml29G1/2 (0.33×12.7 mm) Insulin Syringe. The needle, points upwards, pierces the self-sealing septum of the inverted gas collection vial, that is then immersed in an ice bath (“J”), where low temperature reduces the molecular energy of the evolved gases and increases their solubility in MilliQ water. Elevation of the reaction vessel 20 cm above the gas collection vial creates a pressure gradient that further improves solubility of evolved gases in the Milli-Q water. The wall of the reaction vessel is perforated at mid-level, on opposite sides, for insertion of two rod-shaped electrodes (“D” and “E”), the holes for which are slightly smaller than 2 mm, the nominal electrode diameter, to ensure a tight fit. The electrodes are graphite rods prepared from 65 mm long, 2.0 mm diameter, June Gold brand 4B mechanical pencil leads, sleeved with an electrically insulating heat-shrink tube (Santa Cruz Electronics flexible Polyolefin TT100 3/32″) that restricts the surfaces available for electrochemical reactions to the 0.031 cm² cross-sectional areas at the end.

### 2. Method

For each electrolysis run, the reaction vessel was filled with 120 ml of electrolyte, leaving ˜2 cm of head room between the surface of the liquid and the underside of the screw lid. The electrolyte was coarsely filtered, natural seawater. The reaction vessel was placed on a magnetic stirring plate (“F”) and the electrolyte was stirred by a Teflon-covered magnet at ˜180 rpm throughout each run. The gas collection vial was filled to the brim with Milli-Q water and sealed by the septum in a way that ensured no air was trapped within the vial. The experiment were performed inside a fume hood maintained at room temperature and atmospheric pressure. Electrolysis was powered by a programmable DC power supply (Xantrex XFR 100-28, XFR 2800-Watt Series) (“H”) connected to the electrodes via an in-line ampere meter (Fluke 289 True-RMS multimeter) (“G”) for monitoring the electrical current. Each electrolysis run lasted 20 min, and was initiated by turning on the power, with the voltage preset to a desired value. At the 20 min mark, the power was shut off, and a sample of Milli-Q water containing the evolved mixed gases was immediately drawn with a 1.0 cc hypodermic syringe and loaded into a Dionex ICS-2000 liquid ion chromatography (IC) system with a Dionex IonPac AS-18 IC column. A series of electrolysis runs was carried out with specified voltages between 10 and 90 V with the corresponding J varying from ˜1 to ˜23 A cm⁻².

After each run, the reaction vessel was cleaned to remove any residue adhering to its inner walls, and the faces of the paired electrodes were refreshed (i.e., polished smooth). The gas collection vial was also flushed three times with Milli-Q water to remove any residual traces of chemicals present in the vial.

The IC system measured the electrical conductance of chloride (Cl) ions in microsiemens (uS) and used to measure chlorine concentration [Cl]. Before each analysis the IC system was given several Milli-Q water purges to flush its analysis column until the baseline chlorine ionic concentration stabilized below 0.02 μS. The concentration of eluent—the carrier fluid into which each sample was injected—was set to 35 mM, in reference to the concentrations of H″ and OH electrically generated by the liquid IC system.

### 3. Results

### (i) Electrode Durability

The graphite electrodes serving as cathodes showed durability with only slight roughening and a minor amount of whitish mineral deposition (without being bound by a particular scientific theory, the aragonite isomorph of calcium carbonate plus magnesium hydroxide, as seen at lower current densities). On the graphite anodes, about a 2-3 mm length of the rod-shaped electrode disintegrated over the course of a 20 min run (creating a shallow ‘socket’ within its plastic sleeve), and formed a thin, dark slurry within the continuously agitated electrolyte.

### (ii) Gas Evolution

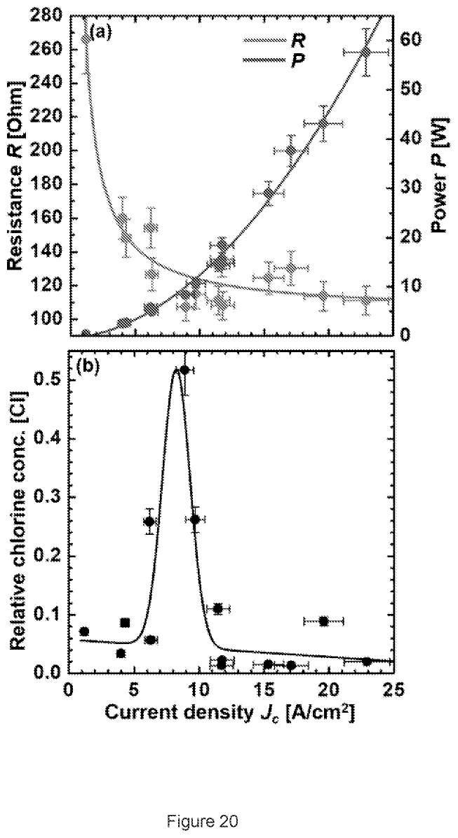

Electrical resistance R in ohms (Ω) and electrical power P in watts (W) were calculated using the electrical current I and voltage V recorded at the beginning of each of a series of electrolysis runs performed at a specific J between 1 and 23 A cm⁻². P increased exponentially over the entire J range, while R declined exponentially as J increased and tended to saturate at about 110 Ω when J exceeded ˜10 A cm⁻² (FIG. 20 (a)). By adjusting V to alter P, Jc varied within the specific range expected for the cross-sectional area of the electrodes. P is expected to be:

$$P = {J}_{c}^{2} {S}_{ele} {d}_{gap} {σ}_{EFF}^{- 1}$$

where Sₑₗₑ is the area (in m²) actively participating in electrolysis, d_{gap} is the gap between electrodes (m), and @ EFF the effective electrical conductivity (S S⁻¹) of electrolyte. Since d_{gap} is fixed, the parabolic curve of P (blue line in FIG. 20a) indicates Sₑₗₑ σ_{EFF}⁻¹ is constant or approaches constancy with increasing J. The effective volume V_{EFF}(m³):

$${V}_{EFF} = {S}_{ele} {d}_{gap}$$

V_{EFF} governs the overall electrical transport during electrolysis, while σ_{EFF} represents the net contribution to electrical transport relevant to the electrolysis. Together, V_{EFF} and σ_{EFF} include contributions from all mechanisms (including ionic transport through the electrolyte, and electrochemical reactions expressed in terms of the exchange current at the surface of the electrodes) that transport electrical charges between the anode and the cathode. The effective resistance R, calculated as:

$$R = {S}_{ele}^{- 1} {σ}_{EFF}^{- 1} {d}_{gap}$$

is expected to remain constant if Sₑₗₑ⁻¹σ_{EFF}⁻¹ remains constant when J_{c} is varied, suggesting that the significant decline of R as J_{c} rises to ˜10 A cm⁻² is the result of Sₑₗₑ⁻¹σ_{EFF}⁻¹ decreasing substantially as J_{c} increases. As R asymptotically approaches a constant value with increasing J_{c} (Red line in FIG. 20a), then Sₑₗₑ⁻¹σ_{EFF}⁻¹ also approaches a constancy at higher J_{c} (further evidence that Sₑₗₑ⁻¹σ_{EFF}⁻¹ must be constant). As J increased, the proxy concentration of chlorine species [Cl] remained low (˜0.06) at J_{c} less than ˜6 A cm⁻², increased rapidly as J exceeded ˜6 A cm⁻² to a maximum of ˜0.52 at J_{c}˜9 A cm⁻², declined equally rapidly to about 0.05-0.06 at (J_{c}˜12 A cm^{[-2}) (similar to [Cl] below ˜6 A cm⁻²), and then [Cl] remained below 0.05 for further increases in J (FIG. 20b). Since J, represents the rate at which electrical charges pass through unit area per unit time, the chlorinous gases collected over a fixed period of time are expected to rise if CER is the dominant process. This distinctive pattern of [Cl] dependence on J_{c}—initial abrupt rise and subsequent rapid fall—is the major discovery in the present study. Although [Cl] remained almost constant (at 0.02-0.04) beyond its peak J_{c} range (˜6 A cm⁻² to ˜12 A cm⁻²), the overall electrolysis process became increasingly unstable above ˜12 A cm⁻², with spontaneous ignition of evolved gases generated on the electrodes and failure to maintain a specific J over the period of time necessary for quantification of [Cl]. This suggests the maximum operational current density (Jmax) at which CER is minimized is approximately 12 A cm⁻², and Jₘₐₓ is expected to provide the maximum production of hydrogen per unit time at the cathode while CER is minimized at the anode. The experimental apparatus was not designed to measure the amount of hydrogen produced at the cathode, but a calculation based on the mathematical form of Faraday's Laws (see Supplement) indicates that the amount of hydrogen generated at the cathode at/max was 158 mlh⁻¹. This is a substantially higher rate of hydrogen production than in conventional electrolysis at lower J (i.e.,)<1 A cm⁻²) [4]. The increases in temperature by 13° C. on average noted in the electrolyte within our 120 ml reaction chamber over a 20 min run relates to a theoretical energy conversion efficiency for hydrogen production of 94.3% (assuming no side products are stoichiometrically contributing to the waste heat). This result may be high in some cases, because the temperature of the seawater electrolyte heated, cooled slightly, and then heated again during a 20 min run.

The ˜13° C. rise in our 120 ml reaction vessel during a 20-min run at/max converts to a rate of ˜8.33 E-5° C. ml⁻¹ s⁻¹. As seen in FIG. 20a, P was ˜17.5 W at Jₘₐₓ, which suggests only ˜30% of the applied electrical power (ignoring any heat dissipation that occurred naturally) was converted into heat, given the specific heat of seawater as ˜4 kJ kg⁻¹ K⁻¹ at 300 K [8]. While the reaction vessel was not equipped with any passive or active cooling to forcibly remove heat generated during electrolysis, the apparatus could be modified to remove the waste heat for seawater electrolysis at higher/at industrial scales.

### 4. Finite Element Modeling

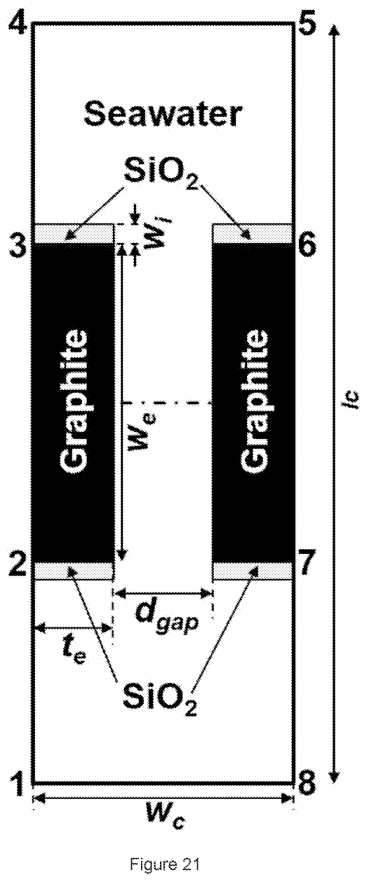

Without being bound by a particular scientific theory, there may be multiple, interdependent and/or independent, underlying mechanisms (e.g., overall thermodynamics associated with reduction/oxidation potentials and reaction kinetics at the electrodes) that may alter characteristics of electrolysis at higher J, and lead to the unique dependence of [Cl] on J, seen in FIG. 20b. Modeling based on finite element (FE) analysis explored the implications of using higher J in electrolysis. FIG. 21 illustrates the two-dimensional geometrical domain, 10 cm long (l_{c}) and 4 cm wide (w_{c}) used in the FE modeling electrodes covered by electrically insulating SiO₂ with thickness (width) wᵢ=0.2 cm that restricts the effective electrode width wₑ (and in three-dimensions, the effective diameter of the electrode's surface area). Although heat-shrink tubing was used as the experimental insulating material, SiO₂ was used for FE modeling because it has analogous, well documented, physical properties. The distance between the two electrodes d_{gap} was fixed at 1 cm and tₑ at 1 cm. The white area in FIG. 21 represents seawater. The FE modeling visualized the electric field around the electrodes when a specific Jc was obtained by varying electrode width wₑ to maintain a constant total electrical current Iₜₒₜ of 300 mA flowing between the two electrodes. An electrical potential VA (applied to the left electrode, in reference to that of the right electrode with electrical potential set to 0 V) was set to a specific value that maintained Iₜₒₜ=300 mA for all values of Wₑ. Since the FE modeling treats the geometric domain in FIG. 21 as a single static system of coupled electrical components (i.e., electrodes and seawater), it is not necessary to specify carriers and/or types of electrical current (e.g., electrons, ions, and exchange current at the electrodes) at various sections. Details of material properties, variables, and boundary conditions used in the FE modeling are summarized in Table 1. All further references to the rod-shaped electrodes will be with the terms “small” and “large” to represent wₑ being smaller than d_{gap} and larger than d_{gap}, respectively.

TABLE 1
Details of material properties, variables, and
boundary conditions used in the FE modeling

| | Effective Electrical | Relative |
|---|---|---|
| Material | Conductivity [S/m] | permittivity |
| Graphite | 1.0 × 10³ | 4.0 |
| SiO₂ | 1.0 × 10⁻¹⁴ | 4.2 |
| Seawater | 2.7 × 10⁻¹ | 80.0 |
| Segment/ | | |
| domain | Boundary conditions | Expression |
| 1-2, 3-4, 4-5, | Insulator | n · J = 0 |
| 5-6, 7-8, 8-1 | | |
| 2-3 | Electrical potential | V = V_{A} |
| 6-7 | Electrical ground | V = 0 |
| The entire | Electrical current | ∇ · J = 0 |
| domain | conservation | E = −∇V |
| | | J = σE |

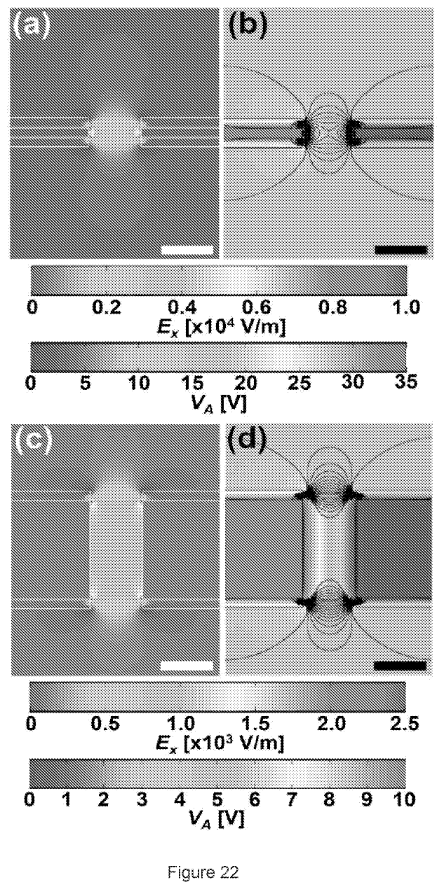

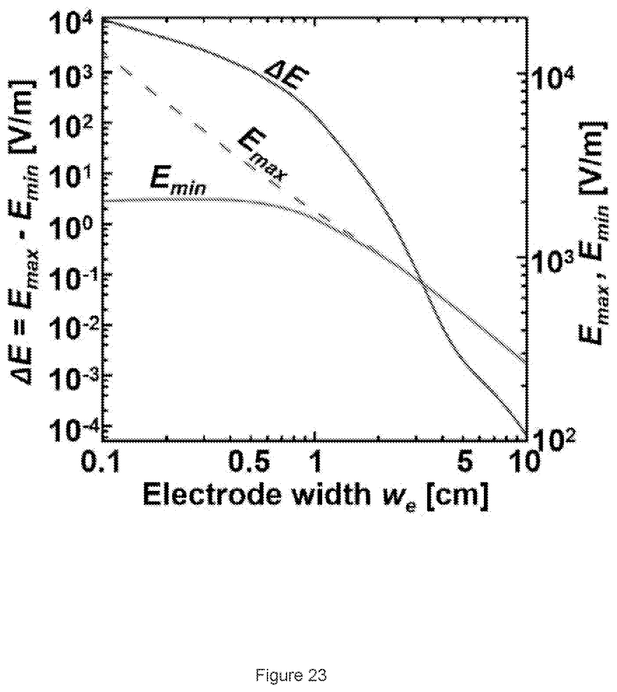

The magnitudes and distributions of the electric fields Ex in seawater, parallel to the x-direction (i.e., x component of the electric field), are shown in color maps and on contour maps superimposed on VA color maps for two electrode widths (wₑ) 0.2 cm (FIGS. 22a and b) and 2.0 cm (FIGS. 22c and 22d). For both electrode widths, two local maxima of Ex are located at the interfaces between the SiO₂ and graphite. However, for small electrodes (wₑ=0.2 cm) the two local maxima merge spatially, resulting in a discernible Ex gradient in the seawater region between the two electrodes (FIG. 22a); this gradient is most clearly seen in FIG. 22b. Some Ex isopleths in FIG. 22b cross the horizontal line connecting the centers of the electrodes (shown as a dot-dash line in FIG. 21). In contrast, for larger electrodes (wₑ=2.0 cm), no Ex isopleths cross the centerline (FIG. 22d), suggesting no noticeable gradient of Ex exists between electrodes, and a substantial portion of Ex leaks out of the region enclosed by the electrodes (FIG. 22c). This leakage from larger electrodes may indicate the presence of sources contributing to unavoidable inefficiencies in conventional electrolysis that employs plates as electrodes, in contrast to the use of a pair of rod electrodes in our demonstration. The highest local Ex for small electrodes (wₑ=0.2 cm) was more than 8 kV m⁻¹ (FIG. 22a), while that for larger electrodes (wₑ=2.0) was ˜3 kVm⁻¹ (FIG. 22c), a difference that is further detailed in FIG. 23.

The FE modeling of this system shows that while Eₘₐₓ decreases monotonically at a constant rate across all wₑ values, Eₘᵢₙ is almost constant as wₑ declines from ˜0.5 cm to 0.1 cm (FIG. 23). Above 0.5 cm, and as wₑ approaches 1 cm, the d_{gap}. specified in our modeling, Eₘᵢₙ increasingly declines until it closely approaches the declining values of Eₘₐₓ. These independent dependencies of Eₘₐₓ and Eₘᵢₙ on Wₑ result in continuous increases in ΔE for wₑ smaller than 1 cm, leading to the differential dΔE/dwₑ of ˜−6E4Vm⁻² for wₑ less than 1 cm, while dΔE/dwₑ is ˜3E-3Vm⁻² for wₑ above 1 cm (i.e., illustrating a considerable influence of wₑ on ΔE for wₑ less than d_{gap}). Thus, in some examples and applications, and for a given total current Iₜₒₜ (a key quantity relevant for designing an electrolysis system), using wₑ smaller than d_{gap} to increase J, may offer substantial benefits by establishing a large gradient of Ex between the electrodes. Such a large gradient of Ex is absent in conventional electrolysis that utilizes larger (i.e., dimensions with a linear length scale larger than 1 cm) planar electrodes.

### Fifth Example: Process Steps for Fabrication of Electrodes

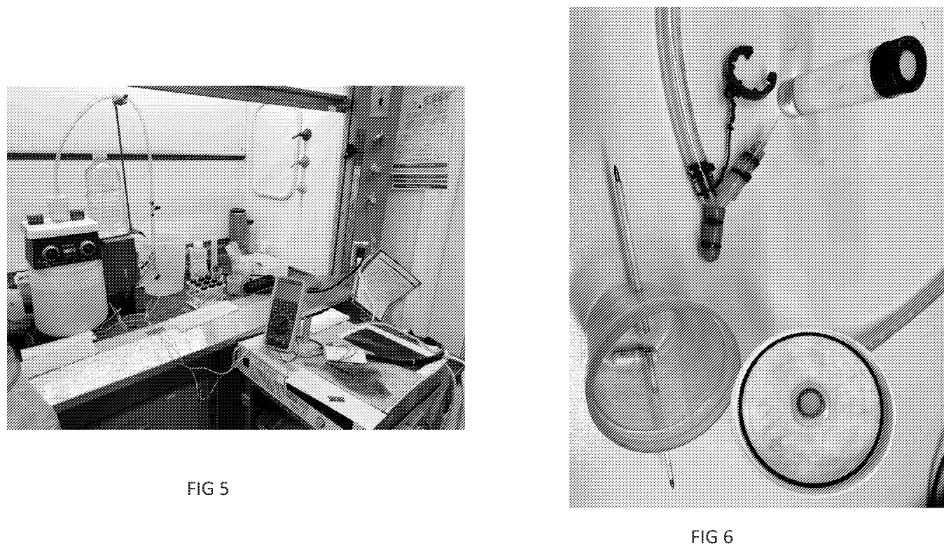

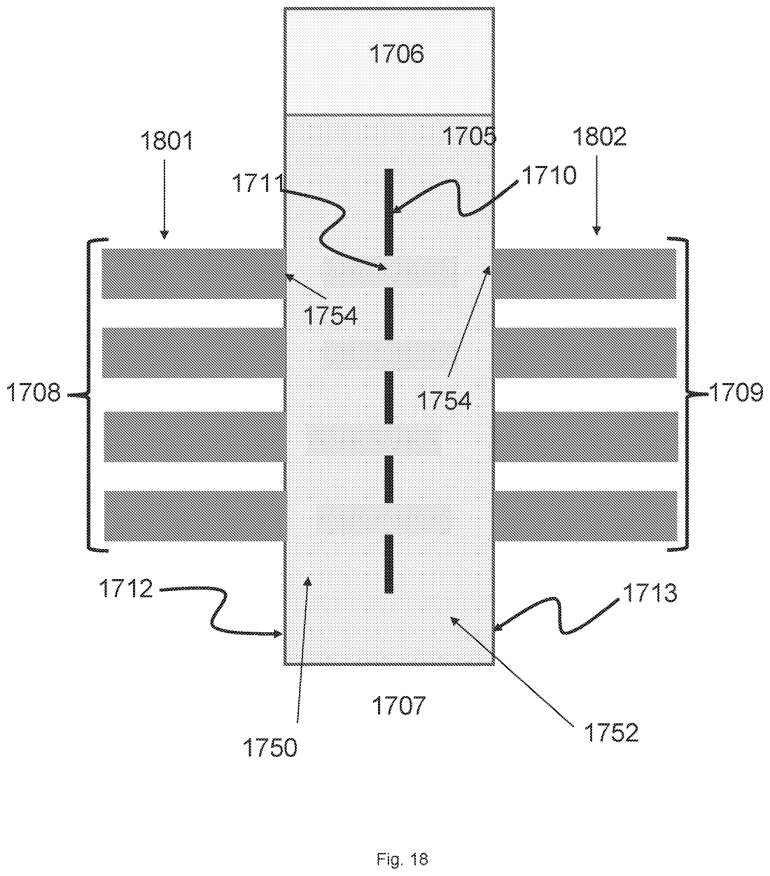

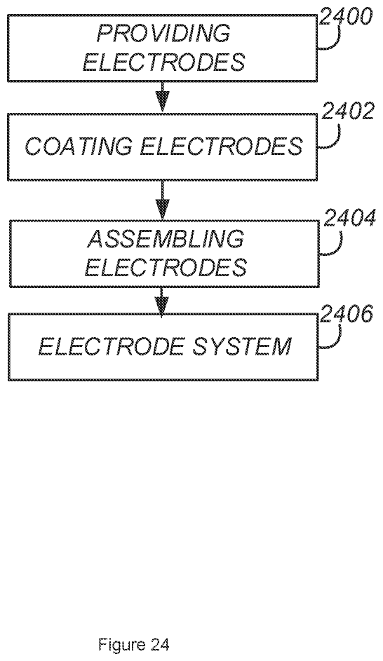

FIG. 24 is a flowchart illustrating a method of making and optionally mounting one or more electrodes (referring also to FIGS. 1-29).

Block 2400 represents providing, fabricating, or obtaining one or more non-planar electrodes having a length and a base at an end of the electrode, e.g., pairs of non-planar electrodes each comprising a first electrode having a first base and a second electrode comprising a second base.

A surface area of the bases (the base of the first electrode and the base of the second electrode) exposed to the fluid are dimensioned to support a current density of the electric current of at least 10 A/cm² or in a range of 10 A/cm² and 14 A/cm².

Block 2402 represents optionally coating the electrodes.

Block 2404 represents optionally mounting/assembling the first electrode and the second electrode in each of the pairs with a spacing between the first base and the second base, so that an electric current may flow through a fluid between the first base and the second base to drive an electrochemical reaction of the fluid.

Block 2406 represents the end result, one or more electrodes, pairs of electrodes, or electrodes mounted in an apparatus. The electrodes and apparatus may be configured in many ways including, but not limited to, the following examples (referring also to FIGS. 1-29) . . .

1. One or more electrodes or an apparatus 200 or kit or system comprising electrodes useful for performing electrolysis, comprising:
one or more non-planar electrodes 23 (e.g., pairs 201 of non-planar electrodes 23, 25 each comprising a first electrode having a first base 22 and a second electrode comprising a second base 24);
optionally a mount 26, 27 mounting the first electrode 23 and the second electrode 25 in each of the pairs with a spacing 28 between the first base and the second base, so that an electric current may flow through a fluid 21 between the first base and the second base to drive an electrochemical reaction of the fluid; and
wherein a surface area A of the bases (the base of the first electrode and the base of the second electrode) exposed to the fluid are dimensioned to support a current density of the electric current of at least 10 A/cm² or in a range of 10 A/cm² and 14 A/cm², and/or the surface area has a largest dimension smaller than the spacing between the bases during the electrochemical reaction, and/or in response to the electric current, the surface area has a largest dimension creating a nonlinear electric field in the spacing and/or an electric field gradient larger than that produced by planar electrodes.

2. The apparatus of example 1, wherein the electrodes have a largest thickness, linear dimension, width, or diameter D, 29 in a range of 0.5 mm-10 mm (e.g., 0.5 millimeters (mm)≤D≤10 mm) and a length L3 in a range of 0.5 cm-2 cm (e.g., 0.5 centimeters (cm)≤L3≤2 cm) . . .

3. The apparatus of examples 1 or 2, wherein the mount 26, 27 comprises:
a first support supporting the first electrodes at a first end 30 opposite the first base 22; and
a second support supporting the second electrodes at a second end 31 opposite the second base.

4. The apparatus of any of the examples 1-3, wherein the mount mounts the first electrode and the second electrode with a spacing 28 between the first base and the second base in a range of 0.5 cm-3 cm (e.g., 0.5 cm≤spacing ≤3 cm).

5. The apparatus of any of the examples 1-4, wherein:
the electrodes comprise an electrochemically active material having sidewalls 33 and a coating 34 on the sidewalls but not on the first base 22 or the second base 24, and
the coating 34 comprises an electrochemically inactive material that does not participate in the electrochemical reaction.

6. The apparatus of example 5, wherein:
the electrodes each have a longitudinal axis L, and
the coating 34 has a thickness T that collapses as the electrochemically active material is consumed and recedes along a direction of the longitudinal axis L during the electrochemical reaction, so as to maintain a constant effective area A of the first base 22 and the second base 24 exposed to the fluid 21 during the electrochemical reaction.

7. The apparatus of any of the examples 1-6, wherein the coating 34 comprises at least one of a metal oxide (e.g., aluminum oxide), a metal nitride (e.g., aluminum nitride), a metal fluoride (e.g., aluminum fluoride) and their compounds (e.g., aluminum oxynitride) or mixtures, and/or an insulating material.

8. The apparatus of any of the examples 1-7, wherein the coating 34 is deposited by chemical vapor deposition such as metal organic chemical vapor deposition, plasma-assisted chemical vapor deposition, or atomic layer deposition, or by physical vapor deposition.

9. The apparatus of any of the examples 5-8, wherein the electrochemically active material 300 comprises, consists of, or consists essentially of metal, carbon, graphite, graphene, one or more rolled graphene sheets, or carbon nanotubes.

10. The apparatus of any of the examples 1-9, further comprising an array 1200 comprising a plurality of the pairs of the electrodes.

11. The apparatus of example 10, wherein:
the first electrode 83 comprises a first longitudinal axis L1,
the second electrode 85 comprises a second longitudinal axis L2, and
the mount 86, 87 aligns the first electrode and the second electrode in each pair such that the first longitudinal axis L1 and the second longitudinal axis L2 are colinear or along a line of sight.

12. The apparatus of example 10 or 11, wherein:
the first electrode 93 comprises a first longitudinal axis L1,
the second electrode 95 comprises a second longitudinal axis L2, and
the mount 96, 97 mounts the first electrode 93 and the second electrode 95 in each pair with an offset 92 such that the first longitudinal axis L1 and the second longitudinal axis L2 are offset in a direction perpendicular to the longitudinal axes.

13. The apparatus of example 10, wherein:
the array comprises 1 dimensional arrays 1708, 1709 of the electrodes comprising the first electrodes in the pairs disposed along a first line 1801 and the second electrodes in the pairs disposed along a second line 1802.

14. The apparatus of any of the examples 10-12, wherein the array 1200 comprises two dimensional arrays of the electrodes, comprising:
the first electrodes disposed in a repeating pattern or lattice of a first unit cell defined by a spacing a1 in a first direction x and a spacing a2 in a second direction y; and
the second electrodes disposed in a repeating pattern or lattice of a second unit cell defined by the spacing a1 in the first direction x and the spacing a2 in the second direction y.

15. The apparatus of any of the examples 1-14, wherein the first electrode 83 and the second electrode 85 have different lengths L3.

16. The apparatus of any of the examples 1-15, wherein the first electrode 103 and the second electrode 105 have different widths 102, 109.

17. The apparatus of any of the examples 1-16 wherein at least one of the first electrode 113 or the second electrode 115 are tapered or comprise a width 119, 112 that varies along a length L3 of the first electrode or the second electrode.

18. The apparatus of any of the examples 1-17, wherein:
the electrodes 23, 25 each comprise a cylinder, a tube, a rod, an elongate member, or a polyhedron having a cross section comprising a polygon or circle and the first base and the second base each comprise a base of the cylinder, the tube, the rod, or the polyhedron, and
the electrodes are optionally symmetrical about the longitudinal axis L of the electrodes.

19. The apparatus of any of the examples 1-18, wherein the width 29 or the diameter or radius of the electrode is selected to be smaller than the gap 28 between the electrodes in a pair of counter electrodes. For example, referring to FIG. 21, Wₑ smaller than d_{gap}.

20. The apparatus of any of the examples 1-19, wherein the width 29 or diameter, or radius or the thickness of the electrode (at least at the base 22, 24) is at least 2 times, at least 4, times, at least 5 times, or at least 10 times smaller than the gap (e.g., referring to FIG. 21, wₑ<<d_{gap}).

21. The apparatus of any of the examples 1-20, wherein the non planar electrodes comprise electrodes having a thickness 29 so that current flows between end/bases 22, 24 of the electrodes (rather than sidewall surfaces as in planar electrodes).

22. The apparatus of an of the examples 1-21, wherein the electrodes are configured to provide distinctive characteristics of electric field distribution for non-planar “e.g., rod-shaped” electrodes (e.g., wₑ<<d_{gap} in FIG. 21, e.g., as seen in FIG. 9(a), as compared to the electric field distribution for conventional planar electrodes (e.g., Wₑ>>dgap in FIG. 21 or as seen in FIG. 8(a).

23. The apparatus of any of the examples 1-22, wherein the non-planar electrodes create a stronger electric field gradient (e.g., nonlinear gradient and/or higher magnitude at the electrode bases 22, 24) across the gap between a pair of electrodes (cathode and anode), in comparison to planar electrodes, e.g., promoting ions to move rapidly between anode and cathode.

24. The apparatus of any of the examples, 1-23, wherein the side walls of the electrodes in the pair are covered by an insulating material, so in principle, no electrical current flows via the side walls.

25. The apparatus of any of the examples 1-25, wherein electrodes are mounted so that the ends 22, 24 of the non planar (e.g., a rod-shaped electrode) are aligned with the inner side of a container (i.e., the electrode is flush with the container inner wall 1752), so only active areas (bases of the electrodes) are exposed to the fluid, e.g., seawater.

26. The apparatus of any of the examples 1-25, wherein the first electrode 23 comprises a cathode and the second electrode 25 comprises an anode.

27. Sixth Example: process steps for making an electrolyzer or system for performing an electrochemical reaction (e.g., electrolysis)

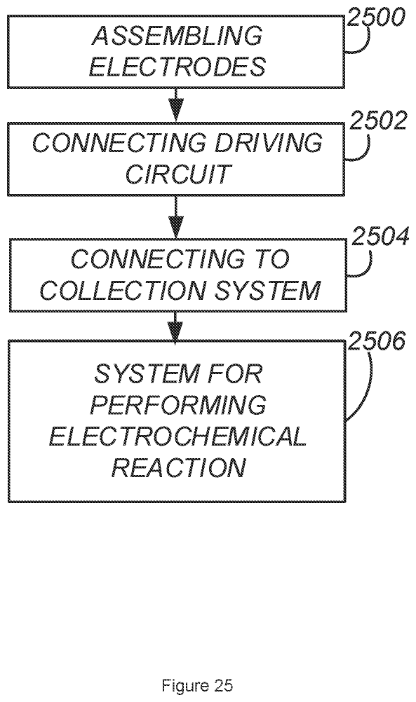

FIG. 25 is a flowchart illustrating a method of making the electrolyzer or system (referring also to FIGS. 1-29).

Block 2500 represents assembling electrodes in a reaction chamber or container for containing a fluid . . .

Block 2502 represents connecting the electrodes to a driving circuit. Block 2504 represents optionally connecting the reaction chamber or container to one or more collection vessels.

Block 2506 represents the end result, a system for performing an electrochemical reaction. The system can be embodied in many ways, including but not limited to, the following (referring also to FIGS. 1-29).

1. An electrolyzer 1707, 1900 (or system for performing electrolysis) comprising the apparatus of any of the examples, further comprising:
a driving circuit 1902 connected to the electrodes and supplying the electric current flowing between the first electrode and the second electrode; and
a container C, 1701, e.g., reaction vessel, for containing the fluid and/or performing electrochemical reaction.

2. The apparatus of any of the examples, wherein:
the fluid comprises seawater or an electrolyte comprising a salt and water,
the electrochemical reaction comprises electrolysis,
the electrolysis outputs a first product, comprising hydrogen, at the first base, and
the electrolysis outputs a second product, comprising oxygen, at the second base.

3. The electrolyzer of examples 19 or 20, wherein the driving circuit 1902 is configured to set the electric current to a level wherein output of chlorine, from the salt in the fluid at the first or second electrode comprising the anode, is suppressed below a target level comprising a negligible level or non-toxic level.

4. The electrolyzer of any of the examples 20-21 wherein the electrolysis outputs:
the oxygen from the seawater at the first electrode comprising an anode via an oxygen evolving oxidation reaction 2 OH⁻(aq)→1/2 O₂(g)+H₂O(I)+2 e⁻, and
hydrogen from the seawater at the second electrode comprising a cathode via a hydrogen evolving reduction reaction 2 H₂O(1)+2e⁻→H₂(g)+2 OH⁻(aq); and
the electrolysis is drive at the current density that suppresses evolution of chlorine and other noxious substances from the seawater at the anode.

5. The system of any of the examples, further comprising a real time monitoring system (e.g., sensor system) In one or more embodiments, monitoring system may perform a real-time measurement of local pH and/or [Cl]. In one or more examples, the sensor can be placed near to the anode to directly assess effects on the dynamic dependence of CER on local pH.

6. The system of any of the examples, further including a system for direct measurement of hydrogen, oxygen and/or heat production, e.g., to determine the efficiency of the electrode system.

7. The system/electrolyzer of any of the examples 1-6, wherein the electrodes comprise the electrodes of any of the examples 1-26 in the fifth example.

### Seventh Example: Method of Making a Container/Reaction Chamber for the Electrochemical Reaction, or System for Gaseous Separation and Collection

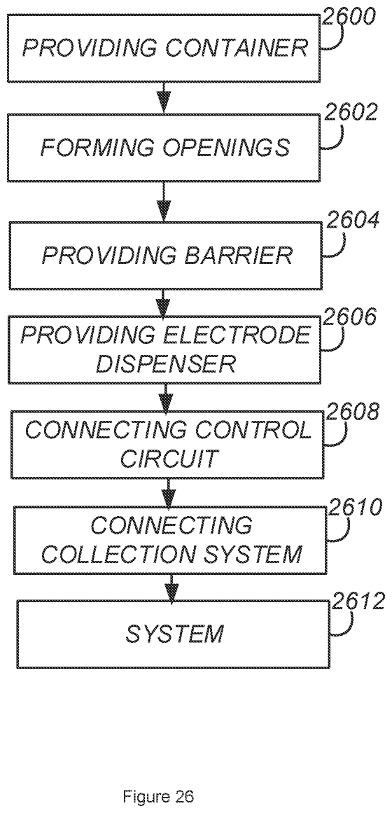

FIG. 26 is a flowchart illustrating a method of making a system for gaseous product separation and collection. (referring also to FIGS. 1-29).

Block 2600 represents providing or making a container/reaction vessel comprising a first compartment for containing a first portion of a fluid; a second compartment for containing a second portion of the fluid during an electrochemical reaction using one or more pairs of electrodes each comprising a first electrode comprising a first end and a second electrode comprising a second end and in a presence of a barrier comprising orifices associated with each of the pairs. Example materials for the container include, but are not limited to, electrically insulating or conductive organic materials (e.g., conducting polymer, non-conducting plastic) and electrically insulating or conductive inorganic materials (e.g., metals, metallic alloys such as stainless steel and brass, and ceramics).

Block 2602 represents forming openings, inlets, outlets and drains.

The step comprises forming one or more first openings or mounts in the first compartment through which each of the first electrodes can be inserted into, or located in, the first portion of the fluid in the first compartment, and positioned relative to its respective second electrode and orifice associated with the pair.

The step further comprises forming one or more second openings or mounts in the second compartment through which each of the second electrodes can be inserted into, or locate in, the second portion of the fluid in the second compartment, and positioned relative to its respective first electrode and orifice associated with the pair

The step further comprises optionally forming one or more first inlets in the first compartment positioned to discharge the first portion of fluid towards the first ends, for replenishing the first portion of fluid during the electrochemical reaction.

The step further comprises optionally forming one or more second inlets in the second compartment positioned to discharge the second portion of fluid towards the second end(s), for replenishing the second portion of fluid during the electrochemical reaction.

The step further comprises optionally forming one or more first drains in the first compartment for collecting a first portion of a solid byproduct of the electrochemical reaction.

The step further comprises optionally forming one or more second drains in the second compartment for collecting a second portion of the solid byproduct of the electrochemical reaction.

The step further comprises optionally forming one or more first outlets in the first compartment for collecting the first gaseous product of the electrochemical reaction evolved at the first end.

The step further comprises optionally forming one or more second outlets in the second compartment for collecting the second gaseous product of the electrochemical reaction evolved at the second end.

Block 2604 represents providing and manufacturing and positioning a non-conductive barrier separating the first compartment from the second compartment, the barrier comprising the one or more orifices connecting the first compartment to the second compartment and spaced and dimensioned to so that, for each pair of the electrodes comprising a first electrode and a second electrode, a second end of the second electrode points towards the associated orifice and faces a first end of the first electrode in the pair, and so that an electric current may flow through the fluid and the associated orifice between the electrodes in the pair.

Example materials for the non-conductive barrier include, but are not limited to, glass, ceramics, polymer (e.g., various plastic, Teflon), rubber, wood, fiber-reinformed composites, and silicate minerals such as mica.

In one or more examples, the barrier further comprises a semipermeable membrane, comprising a material such as, but not limited to, glass fiber mat, Nafion membrane, or any other semipermeable material that allows the passage of ions but blocks or significantly reduces the flow of the fluid. In one or more examples, Nafion may let smaller ions (e.g., proton, sodium and potassium ions) flow through, but block larger molecules (e.g., water molecule—the primary ingredient of seawater, the fluid). In one or more examples, glass fiber mat may not block the fluid, but it would considerably slow down the flow of the fluid in comparison to the flow of ions.

Block 2606 represents optionally connecting an electrode dispenser. The dispenser may comprise a first electrode dispenser positioned to insert the first electrode into the first compartment for driving the electrochemical reaction and removing and/or replacing the first electrode once the first electrode is spent by the electrochemical reaction; and a second electrode dispenser positioned to insert the second electrode into the first compartment for driving the electrochemical reaction and removing and/or replacing the second electrode once the second electrode is spent by the electrochemical reaction.

Block 2608 represents optionally connecting a control circuit for controlling the dispenser and/or controlling the electrical current.

Block 2610 represents optionally connecting a product collection system.

Block 2612 represents the end result, an apparatus (e.g., for gaseous separation and collection).

The system can be embodied in many ways, including, but not limited to, the following examples (referring also to FIGS. 1-29) . . .

1. An apparatus 1707 comprising:
a first compartment A, 1750 for containing a first portion of the fluid 1705;
a second compartment B, 1752 for containing a second portion of the fluid;
a non-conductive barrier 10, 1710 separating the first compartment from the second compartment, the barrier 10, 1710 comprising one or more orifices 3, 1711 connecting the first compartment to the second compartment, each of the orifices associated with a different one of the pairs 201 of the electrodes;
the mount comprising:
one or more first mounts 26, 9 in the first compartment A, 1750, each of the first mounts associated with locating a different one of the first electrodes 1708 in the first portion of the fluid in the first compartment, so that for each one of the pairs 201 of the electrodes, the first base 22 of the first electrode faces the one of orifices 1711 associated with the one of the pairs 201;
one or more second mounts 27, 9 in the second compartment B, 1752, each of the second mounts associated with locating a different one of the second electrodes 1709 in the second portion of the fluid in the second compartment B, 1752, so that:
for each one of the pairs 201 of the electrodes, the second base 24 of the second electrode 1709 faces towards the first base 22 of the first electrode 1708 and the one of the orifices 1711, 3 associated with the one of the pairs 201, and
the electric current may flow through the fluid and the one of the orifices 1711, 3 between the first base 22 and the second base 24 to drive the electrochemical reaction of the fluid outputting a first gaseous product at the first base 22 and a second gaseous product at the second base 24;
a first inlet 4 in the first compartment positioned to discharge the first portion of fluid towards the first base, thereby replenishing the first portion of fluid during the electrochemical reaction;
a second inlet 4 in the second compartment positioned to discharge the second portion of fluid towards the second base, thereby replenishing the second portion of fluid during the electrochemical reaction;
a first drain 5 in the first compartment for collecting a first portion of a solid byproduct of the electrochemical reaction;
a second drain 5 in the second compartment for collecting a second portion of the solid byproduct of the electrochemical reaction;
a first outlet 6 in the first compartment for collecting the first gaseous product of the electrochemical reaction evolved at the first base; and
a second outlet 6 in the second compartment for collecting the second gaseous product of the electrochemical reaction evolved at the second base.

2. The apparatus of example 1, further comprising a semipermeable membrane covering the orifice (the semipermeable membrane comprising a material that allows the passage of ions involved in the electrochemical reaction).

3. The apparatus of example 1, wherein:
the first outlet 6 is at the top of the first compartment above the first electrode to collect the first gaseous product evolving upwards,
the second outlet 6 is at the top of the second compartment above the second electrode to collect the second gaseous product evolving upwards,
the first inlet 4 is at the base of the first compartment and comprises a first nozzle or conduit propelling a jet of the seawater towards the first end,
the second inlet 4 is at the base of the second compartment and comprises a second nozzle or conduit propelling a jet of the seawater towards the second end,
the first drain 5 is in the base of the first compartment, and
the second drain 5 is in the base of the second compartment.

4. The apparatus of any of the examples 1-2, wherein:
the container 1701 comprises a first sidewall 1712 and a second sidewall 1713 separated from the first sidewall by a depth 1703 dimensioned such that the depth 1703 determines (or is equal to) a gap 28 between the first base 22 and the second base 24 in each of the pairs 201 of the electrodes when the mount 26, 27 mounts:
the first base 22 of the first electrode 1708 is flush and/or aligned with the (e.g., inner face of) first sidewall 1712 and
the second base 24 of the second electrode is flush and/or aligned with the (e.g., inner face of) second sidewall 1713.

5 The apparatus of any of the examples 1-3, wherein the one or more first mounts comprise one or more first openings through which the first electrodes can move along their longitudinal axis L, and/or be exposed to the fluid, and the one or more second mounts comprise second openings through which the second electrodes can move along their longitudinal axis and/or be exposed to the fluid.

6. The apparatus of example 4, further comprising:
a first electrode dispenser 8, 9 positioned to insert the first electrodes through the first openings into the first compartment when at least driving the electrochemical reaction or removing the first electrode once the first electrode is spent by the electrochemical reaction; and
a second electrode dispenser 8, 9 positioned to insert the second electrodes through the second openings into the first compartment when at least driving the electrochemical reaction or removing the second electrode once the second electrode is spent by the electrochemical reaction.

7. Example dispensers include, but are not limited to, scissor jacks, or linear single-axis stages [5].

8. The system of example 6, wherein the first electrode dispenser and the second electrode dispenser each comprise at least one of:
an actuator 9 that automatically advances a length of the electrode into the first compartment or the second compartment; or
a magazine 8 for dropping in a new electrode as needed.

9. The apparatus of example 8, wherein the actuator is configured to control a distance 28 between the first base 22 and the second base 24 during the electrochemical reaction.

10. The apparatus of any of the examples 1-9, comprising:
one or more control circuits 200 controlling at least one of:
a distance between a first electrode and a second electrode in response to a feedback comprising a measurement of electric current (e.g., measured using ammeter A) between the first electrode and the second electrode, so that the distance maintains a desired current density of the electric current driving an electrochemical reaction of a fluid in contact with the electrodes;
replacement of the electrodes spent by the electrochemical reaction so as to maintain a desired reaction rate of the electrochemical reaction;
reversal of a polarity of the electric current when certain electrode consumption or cleanliness thresholds are met, so as to allow swapping of the first electrode and the second electrode for keeping the electrodes clean and evenly consuming the first electrode and the second electrode; or
manifolding of gaseous products outputted from the electrochemical reaction.

11. An industrial-sized hydrogen production facility, powered by associated long-term low-cost renewable energy (i.e., so-called Green Hydrogen) comprising the apparatus of any of the examples 1-10.

12. The apparatus of any of the examples 1-11, further including heat mitigation to mitigate potential climate effects of continuous operation of the apparatus at industrial scales.

13. The apparatus of any of the examples 12, further comprising a recycling/reclaiming system for removing and/or recycling/reclaiming the slurry in the seawater electrolyte resulting from the relatively slow disintegration of the graphite electrodes. In one or more example, the slurry may be reclaimable (e.g., by centrifugal separation), and optionally refined as graphene [13].

14. The apparatus of example 13, wherein the reaction chamber/container comprises two sides with a water-permeable diaphragm/separator for removing the waste products or slurry.

15. The apparatus of any of the examples 1-14, wherein each of the first mounts comprise a first opening in the first sidewall of the container dimensioned to (e.g., having the same area as the first base) expose the first base to the fluid; and
each of the second mounts comprise a second opening dimensioned to (e.g., having the same area as second base) expose the second base to the fluid,
and wherein the first opening and the second opening are aligned at the same height so that the first base faces the second base.

16. The apparatus of example 5 and 15, wherein the electrodes are sealed/fixed in their first and second openings in the first and second sidewalls using an appropriate sealant or adhesive, or using a mounting mechanism that allows translation to move the electrodes as they are consumed while preventing leakage of the fluid from the container.

17. The apparatus of any of the examples 1-16 comprising the electrode configuration of any of the examples 1-26 in the fifth example and/or the system of any of the examples 1-16 of the sixth example comprising the apparatus of any of the examples 1-26 of the fifth example.

### Eighth Example: Method of Performing an Electrochemical Reaction

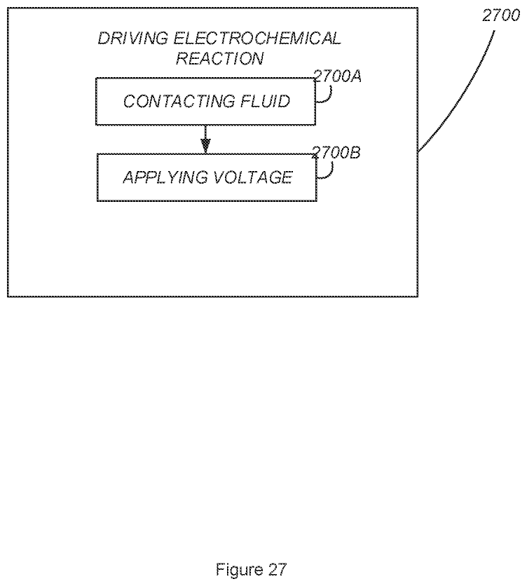

FIG. 27 is a flowchart illustrating a method of performing an electrochemical reaction using one or more pairs or electrodes comprising a first electrode having a first base and a second electrode having a second base (e.g., any of the electrodes of examples 1-19 in the fourth example).

Block 2700 represents driving an electrochemical reaction with a current density in excess of 4 amps per centimeter square, e.g., so as to suppress evolution of chlorine or other noxious substances (e.g., bromine) from the seawater during the electrolysis. The step may comprise the following steps:
contacting a fluid with one or more pairs of non-planar electrodes each comprising a first electrode having a first base and a second electrode comprising a second base, and
applying a voltage difference between the first electrode and the second electrode in each of the pairs so that an electric current flows through the fluid between the first base and the second base, wherein:
the electric current drives an electrochemical reaction of the fluid; and
a surface area of the bases (the base of the first electrode and the base of the second electrode) exposed to the fluid are dimensioned to support a current density of the electric current of at least 10 A/cm² or in a range of 10 A/cm² and 14 A/cm².

The method can be performed in many ways, including, but not limited to the following examples (referring also to FIGS. 1-29).

1. In one example, the fluid comprises seawater or an electrolyte comprising salt and water, the electrochemical reaction comprises electrolysis, the electrolysis outputs a first product, comprising hydrogen, at the first base, and the electrolysis outputs a second product, comprising oxygen, at the second base, and the method further comprises increasing the electric current to a level wherein output of chlorine, from the salt in the fluid at the first or second electrode comprising the anode, is suppressed below a target level comprising a negligible level or non-toxic level.

2. In one or more examples, the oxygen from the seawater or the fluid at the first electrode (comprising the anode) is produced via an oxygen evolving oxidation reaction 2 OH⁻(aq)→1/2 O₂(g)+H₂O(l)+2 e⁻, and the hydrogen from the seawater or the fluid at the second electrode (comprising a cathode) is produced via a hydrogen evolving reduction reaction 2 H₂O (1)+2e→H₂(g)+2 OH⁻(aq).

3 In one or more examples, the driving current, electrode dimension, and electrode separation are selected so that at least one of:
a balance between chemical and electrical potential occurs at the electrode/electrolyte interface in a charged region known as the double layer.
an activation energy for the ions and molecules participating in the transfer of electrons is provided,
an electrical potential is applied, that is generally described by the Butler-Volmer equation, breaking a dynamic equilibrium enabling control of reduction vs. oxidation,
when the diffusion of ions between electrodes is the rate-limiting process determining total current Iₜₒₜ for a given VA, the concentration gradient of ions carrying electrical current across the distance between the electrodes d_{gap} is maintained; even as fresh electrolyte is continuously being injected into the region between the electrodes,
a sufficiently substantial gradient of the electrical field Ex (i.e., the component of electric field perpendicular to the effective plane—the surface on which electrochemical reaction takes place-associated with an array of electrodes) is provided, benefitting ion transport from one electrode to the other even in poorly developed ion concentration gradient required for simple diffusion, or
evolution of particular products (e.g. chlorine).

4. In one or more embodiments, evolution of the product is suppressed or controlled, or the electrochemical reaction is otherwise controlled, by controlling (and monitoring) the resistance R or conductivity of the electrolyte (fluid comprising the salt). For example, the inventors have found that the presence of a substantial difference ΔEₓ between maximum and minimum Ex over d_{gap} for particular current densities Jc and smaller electrode area wₑ qualitatively explains the observation that resistance R drops significantly for J_{c} larger than 10 A cm⁻² (FIG. 20a). The rapid decline of Sₑₗₑ⁻¹σ_{EFF}⁻¹ as J (rises to ˜10 A cm⁻² does account qualitatively for the sudden decrease in R. Since electrode size Sₑₗₑ is the fixed cross-sectional area of the electrodes, the effective conductivity of the electrolyte σ_{EFF} must increase, which is possible when a large ΔE, amplifies the drift of ions in the electrolyte (FIG. 20a). 5. In one or more examples evolution of the product is suppressed or controlled, or the electrochemical reaction is otherwise controlled, by controlling the acidity of the fluid local to the electrodes by appropriate selection of the electric field. For example, the inventors have found that, when chlorine evolving reactions CER dominate electrolysis of seawater (e.g., when Jc is ˜1 A cm⁻²), chlorine reacting with water at the anode produces H⁺ ions making the area adjacent to the anode more acidic, which further promotes CER. In contrast, a large ΔEₓ (as in the experiment done at J_{c}>12, A cm⁻²) encourages H⁺ ion movement from anode to cathode and hinders CER by making the area adjacent to the anode less acidic. Simultaneously, a large ΔEₓ efficiently transports OH⁻ ions produced at the cathode to the anode where they further reduce acidity and increase suppression of CER. Maintaining less acidic areas near the anode also alters the kinetics at the anode by modifying the characteristics of the double layer over the length scale compared to the Debye length that depends on pH [9]. Other electrochemical mechanisms in addition to the alteration of pH near the anode are also likely to contribute to the CER decline when J_{c} exceeds 12 A cm⁻².

6. In one or more examples, the evolution of certain products of the electrolysis may be controlled by operating the electrolysis below, above, or within certain current density ranges. For example, the inventors found the rapid rise of [Cl] after J_{c} reaches ˜5 A cm⁻². Without being bound by a particular scientific theory, such hindrance may come from various sources (e.g., overpotentials of different types) operating independently or collectively.

7. In one or more examples, the method may be configured to initiate electrolysis by reducing resistance R. or of the electrolyte by appropriate setting of the electric field. In one or more examples, modeling indicates a strong gradient in Eₓ(>1×103Vm⁻¹) between the electrodes can be used to engineer a major decline in [Cl] at higher J_{c} via a significant reduction in @ EFF. In one or more examples, a sufficiently large ΔE between the electrodes is engineered for a decline in [Cl] when a threshold Jₘₐₓ is reached.

8. In one or more examples, the nonlinear dependence of electric field around the ends of the electrodes, as a function of the current density, may be leveraged to control (e.g., the evolution of the products of) the electrochemical reaction. This is possible because, in some examples, the spatial distribution of the electric field between a pair of the electrodes may change in a non-linear way depending on J_{c}., in contrast to the spatial distribution of the electric field between a pair of conventional electrodes (e.g., planar electrode) remaining fairly steady for various J_{c}. For example, the non-linear characteristics of the electric field between a pair of electrodes may be selected to delay the onset of electrolysis and/or suppress the production of substances containing chlorine. In one example, Cl evolution is delayed for current densities J (below ˜5 A cm⁻² or above 10 A cm⁻². In yet further examples, the current density is set to avoid ranges wherein evolution of certain electrolysis products (e.g., [Cl]) that start to rise non-linearly and abruptly followed by an abrupt fall. In one or more examples, [Cl] evolution rises nonlinearly at J_{c}˜5 A cm⁻² and falls abruptly after J_{c} exceeds 10 A cm⁻². In another example, [Cl] increases continuously as J, rises to ˜8 A cm⁻², and then [Cl] declined rapidly to negligible levels for J, above 12 A cm cm⁻²

9. In one or more examples, larger electric fields and larger J_{c} are selected to reduce CER and increase the hydrogen generation rate, e.g., using J, at least one order of magnitude higher than J (˜1 A cm⁻².

10. The method of any of the examples, e.g., any of the examples 1-9, wherein the method is performed using the system of any of the examples in the fifth example, sixth example, or seventh example.

11. The method of any of the examples, e.g., any of the examples 1-10, wherein the driving current, electrode dimension, and electrode separation is determined using FE modeling.

12. The method of any of the examples, e.g., any of the examples 1-11, wherein the electrochemical reaction implemented with the apparatus and methods described herein is configured and operated so as to produces no harmful species.

13. The method of any of the examples, e.g., any of the examples 1-12, wherein the electrochemical reaction comprises any reaction (e.g., a reaction that generates chlorine species and that generates deposition of calcium carbonate) associated with the main reaction (i.e., oxidation and reduction of water molecules).

14. The method of any of the examples, e.g., any of the examples 1-13, wherein the electrochemical reaction is a reaction that produces hydrogen and oxygen.

15. The method of any of the examples, e.g., any of the examples 1-14, wherein the electrochemical reaction is a reaction comprising oxidation and reduction of molecules, compounds, or other components in the fluid (e.g., electrolyte).

16. The method of any of the examples, e.g., any of the examples 1-15, wherein the electrochemical reaction (e.g., Electrolysis) is a process used in various industrial purposes e.g., electroplating to deposit a thin layer of metal, producing alkali metals (e.g., sodium hydroxide and potassium hydroxide) from seawater, refining and extracting metals (e.g., copper, zinc, aluminum) from ores, or obtaining lithium from an appropriate electrolyte or material.

17. The method of any of the examples 1-16 implemented using the electrode configuration of any of the examples 1-26 in the fifth example and/or the system of any of the examples 1-7 of the sixth example comprising the apparatus of any of the examples 1-26 of the fifth example, or the apparatus of any of the examples 1-17 of the seventh example.

18. The method of any of the examples 1-18, wherein the fluid (e.g., electrolyte) comprises a molten material (e.g., molten solid or molten electrolyte) or slurry.

### Ninth Example: Hardware Environment

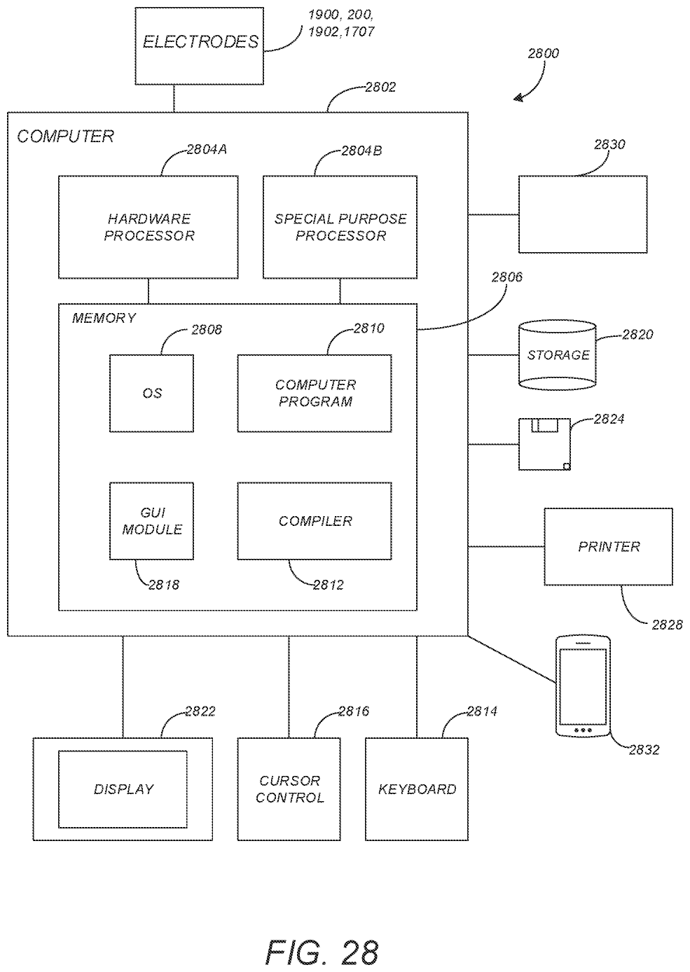

FIG. 28 is an exemplary hardware and software environment 2800 (referred to as a computer-implemented system and/or computer-implemented method) used to implement one or more embodiments of the invention. The hardware and software environment includes a computer 2802 and may include peripherals. Computer 2802 may be a user/client computer, server computer, or may be a database computer. The computer 2802 comprises a hardware processor 2804A and/or a special purpose hardware processor 2804B (hereinafter alternatively collectively referred to as processor 2804) and a memory 2806, such as random access memory (RAM). The computer 2802 may be coupled to, and/or integrated with, other devices, including input/output (I/O) devices such as a keyboard 2814, a cursor control device 2816 (e.g., a mouse, a pointing device, pen and tablet, touch screen, multi-touch device, etc.) and a printer 2828. In one or more embodiments, computer 2802 may be coupled to, or may comprise, a portable device 2832 (e.g., cellular device, mobile phone, laptop, tablet) or multi-touch device or other internet enabled device executing on various platforms and operating systems.

In one embodiment, the computer 2802 operates by the hardware processor 2804A performing instructions defined by the computer program 2810 (e.g., an application) under control of an operating system 2808. The computer program 2810 and/or the operating system 2808 may be stored in the memory 2806 and may interface with the user and/or other devices to accept input and commands and, based on such input and commands and the instructions defined by the computer program 2810 and operating system 2808, to provide output and results.

Output/results may be presented on the display 2822 or provided to another device for presentation or further processing or action. The image may be provided through a graphical user interface (GUI) module 2818. Although the GUI module 2818 is depicted as a separate module, the instructions performing the GUI functions can be resident or distributed in the operating system 2808, the computer program 2810, or implemented with special purpose memory and processors. In one or more embodiments, the display 2822 is integrated with/into the computer 2802 and comprises a multi-touch device having a touch sensing surface. Some or all of the operations performed by the computer 2802 according to the computer program 2810 instructions may be implemented in a special purpose processor 2804B. In this embodiment, some or all of the computer program 2810 instructions may be implemented via firmware instructions stored in a read only memory (ROM), a programmable read only memory (PROM) or flash memory within the special purpose processor 2804B or in memory 2806. The special purpose processor 2804B may also be hardwired through circuit design to perform some or all of the operations to implement the present invention. Further, the special purpose processor 2804B may be a hybrid processor, which includes dedicated circuitry for performing a subset of functions, and other circuits for performing more general functions such as responding to computer program 2810 instructions. In one embodiment, the special purpose processor 2804B is an application specific integrated circuit (ASIC) or field programmable gate array (FPGA).

The computer 2802 may also implement a compiler 2812 that allows an application or computer program 2810 written in a programming language such as C, C++, Assembly, SQL, PYTHON, PROLOG, MATLAB, RUBY, RAILS, HASKELL, or other language to be translated into processor 2804 readable code. Alternatively, the compiler 2812 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 2810 accesses and manipulates data accepted from I/O devices and stored in the memory 2806 of the computer 2802 using the relationships and logic that were generated using the compiler 2812.

The computer 2802 also optionally comprises an external communication device such as a modem, satellite link, Ethernet card, or other device for accepting input from, and providing output to, other computers 2802.

In one embodiment, instructions implementing the operating system 2808, the computer program 2810, and the compiler 2812 are tangibly embodied in a non-transitory computer-readable medium, e.g., data storage device 2820, which could include one or more fixed or removable data storage devices, such as a zip drive, floppy disc drive 2824, hard drive, CD-ROM drive, tape drive, etc. Further, the operating system 2808 and the computer program 2810 are comprised of computer program 2810 instructions which, when accessed, read and executed by the computer 2802, cause the computer 2802 to perform the steps necessary to implement and/or use the present invention or to load the program of instructions into a memory 2806, thus creating a special purpose data structure causing the computer 2802 to operate as a specially programmed computer executing the method steps described herein. Computer program 2810 and/or operating instructions may also be tangibly embodied in memory 2806 and/or data communications devices 2830, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 2802.

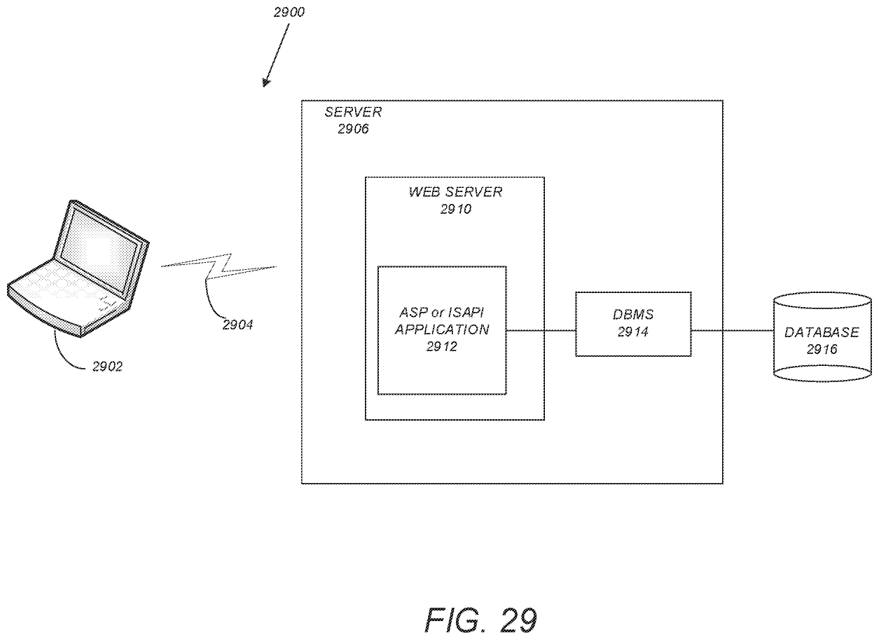

FIG. 29 schematically illustrates a typical distributed/cloud-based computer system 2900 using a network 2904 to connect client computers 2902 to server computers 2906. A typical combination of resources may include a network 2904 comprising the Internet, LANs (local area networks), WANs (wide area networks), SNA (systems network architecture) networks, or the like, clients 2902 that are personal computers or workstations (as set forth in FIG. 28), and servers 2906 that are personal computers, workstations, minicomputers, or mainframes (as set forth in FIG. 28). However, it may be noted that different networks such as a cellular network or otherwise), or any other type of network may be used to connect clients 2902 and servers 2906 in accordance with embodiments of the invention.

A network 2904 such as the Internet connects clients 2902 to server computers 2906. Network 2904 may utilize ethernet, coaxial cable, wireless communications, radio frequency (RF), etc. to connect and provide the communication between clients 2902 and servers 2906. Further, in a cloud-based computing system, resources (e.g., storage, processors, applications, memory, infrastructure, etc.) in clients 2902 and server computers 2906 may be shared by clients 2902, server computers 2906, and users across one or more networks. Resources may be shared by multiple users and can be dynamically reallocated per demand. In this regard, cloud computing may be referred to as a model for enabling access to a shared pool of configurable computing resources.

Clients 2902 may execute a client application or web browser and communicate with server computers 2906 executing web servers 2910. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 2902 may be downloaded from server computer 2906 to client computers 2902 and installed as a plug-in or ACTIVEX control of a web browser. Web server 2910 may host an Active Server Page (ASP) or Internet Server Application Programming Interface (ISAPI) application 2912, which may be executing scripts.

Generally, these components 2900-2916 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 2902 and 2906 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 2902 and 2906. Embodiments of the invention are implemented as a software/application on a client 2902 or server computer 2906. Further, as described above, the client 2902 or server computer 2906 may comprise a thin client device or a portable device that has a multi-touch-based display.

### Advantages and Improvements

FIG. 20 shows that, utilizing the apparatus of FIG. 2, wₑ have identified an electrochemical regime of relatively high current density (˜12-14 A/cm∧2) at which the evolution of chlorine gas drops to negligible levels. This result is surprising, given that Bockris [1] projected the threshold current density to be orders of magnitude lower.

Embodiments of the present invention disclosed herein overcome the challenges with regards to hardware, electrolyte depletion, and access to seawater needed to process the sheer amount of concentrated DC electricity required to efficiently generate hydrogen from electrolysis of seawater. Conventional electrolysis systems frequently use coatings of expensive catalytic chemical elements (CCEs) applied to the anode to suppress CER and promote OER. In other words, conventional electrolysis systems require CCEs engineered through complex preparation procedures, so that high-volume scaling would be very costly. Furthermore, conventional electrolysis systems operated with Je ˜1 A/cm² severely restrict the rate at which hydrogen is produced per unit time at the cathode (i.e., hydrogen production rate), which unavoidably drives up the cost of the resulting hydrogen.

In addition, the systems described herein have enabled study of:
previously unexplored high-power electrochemical reactions within a highly conductive fluid;
the effects of concurrent extreme corrosivity at the anode and appreciable heat production;
the challenges inherent to rapidly quantifying reactive chlorine species (i.e., chlorine-containing compounds, including HOCl and chloramines, capable of chlorinating and oxidizing other molecules; and
challenges resulting from the production of troublesome byproducts and unintended consequences, etc.

These studies identified favorable current density conditions for the extraction of hydrogen at low chlorine evolution levels and hardware features required to provide these conditions in a practical environment.

The inventors' discovery that hydrogen can be obtained from electrolysis of seawater with negligible chlorine evolution is surprising and unexpected in view of the conventional art which describe:
impractical heating and power consumption at the operation of several thousand mA/cm∧2 necessary to achieve high coulombic oxygen
efficiency [2]; and #challenging to reach high currents at an electrode potential where chlorine evolution is not yet allowed [3]

Example systems described herein overcome the heating and high current challenges by utilizing non planar electrodes. Specifically, maintaining stable EOS with higher J_{c} is challenging for conventional electrolysis systems that employ a pair of planar electrodes with effective surface areas >1 cm². On the other hand, an electrolysis system using non-planar electrodes, as described herein, enables durable EOS with higher J_{c}>10 A/cm² without using expensive CCEs, so as to significantly reduce CER at the anode and increase the hydrogen production rate at the cathode. Moreover, heating levels in an example system described herein did not present a problem for the operation and practical extraction of hydrogen. The efficiency of the device allows a power consumption that can be supplied using photovoltaic device having modern day photovoltaic conversion efficiencies.

In one or more examples, the present disclosure further discloses the non-obvious feature of regulating just enough fluid (electrolyte) into the reaction vessel to prevent depletion of the electrolyte during the electrolysis reaction.

Another advantageous features of the appartus is its scalability. For instance, for a given effective electrode area, an array of non-planar 3D (e.g., rod-shaped electrodes) is more scalable and more advantageous in maintenance than a single planar electrode because replacing one massive and heavy planar electrode is more formidable than replacing multiple rod-shaped small light-weight electrodes. Moreover, in embodiments that automatically replenish consumed rod-shaped electrodes, maintenance may not be required.

### REFERENCES

The following references are incorporated by reference herein.

[1] Bockris, J. O′M. The Solar-Hydrogen Alternative, Wiley, New York (1975), projecting, via FIG. 9.18, that at a high enough current density, chlorine evolution is reduced.

[2] https://www.sciencedirect.com/science/article/pii/036031998090021X

[3] Dionigi et al. (2016): https://www.technischechemie.tu berlin.de/fileadmin/fg109/Publikationen/2016_Design_Criteria_Operating_Conditio ns_and_Nickel-Iron_Hydroxide_Catalyst Materials for Selective_Seawater_Electrolysis_01.pdf

[4] Dresp et al (2019): https://pubs.acs.org/doi/10.1021/acsenergylett.9b00220 provides review of the status of clean hydrogen via seawater electrolysis.

[5] (https://us.misumi-ec.com/vona2/detail/221302456702/?HissuCode=KXL06050-N1-C&gclid=CjwKCAjwpayjBhAnEiwA-7ena4k8FxtqvS5SdyV3rBaGI0HPgaxnTlh3tf6xZHnxTSDR9A_vDYQcFBoCOVOQA vD BwE

[6] Koster JW et al., Explicitly controlling electrical current density overpowers the kinetics of the chlorine evolution reaction and increases the hydrogen production during seawater electrolysis, International Journal of Hydrogen Energy, https://doi.org/10.1016/j.ijhydene.2022.11.053

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An apparatus, comprising:
one or more non-planar electrodes each comprising a length and a base at the end of the length, wherein:
the base comprises a surface area dimensioned to support a current density of an electric current when a pair of the electrodes are disposed with a spacing between the bases so that the electric current flows through a fluid between the bases to drive an electrochemical reaction of the fluid.

2. The apparatus of claim 1, wherein:
the surface area is dimensioned to support the current density of at least 10 A/cm² or in a range of 10A/cm² and 14 A/cm², and/or
the surface area has a largest dimension smaller than the spacing between the bases during the electrochemical reaction, and/or
in response to the electric current, the surface area has a largest dimension creating a nonlinear electric field in the spacing and/or an electric field gradient larger than that produced by planar electrodes.

3. The apparatus of claim 1, further comprising:
one or more of the pairs of the electrodes comprising a first electrode comprising the base comprising a first base and a second electrode comprising the base comprising a second base; and
a mount mounting the first electrode and the second electrode in each of the pairs with the spacing between the first base and the second base, so that the electric current may flow through the fluid between the first base and the second base to drive an electrochemical reaction of the fluid.

4. The apparatus of claim 1, further comprising:
one or more of the pairs of the electrodes comprising a first electrode comprising the base comprising a first base and a second electrode comprising the base comprising a second base;
a container, comprising a first compartment for containing a first portion of the fluid; and a second compartment for containing a second portion of the fluid;
a non-conductive barrier separating the first compartment from the second compartment, the barrier comprising one or more orifices connecting the first compartment to the second compartment, each of the orifices associated with a different one of the pairs of the electrodes;
one or more first mounts or locators on the first compartment, each of the first mounts associated with locating and/or mounting a different one of the first electrodes in the first portion of the fluid in the first compartment, so that for each one of the pairs of the electrodes, the first base of the first electrode faces the one of orifices associated with the one of the pairs;
one or more second mounts or locators on the second compartment, each of the second mounts associated with locating and/or mounting a different one of the second electrodes in the second portion of the fluid in the second compartment, so that:
for each one of the pairs of the electrodes, the second base of the second electrode faces towards the first base of the first electrode and the one of the orifices associated with the one of the pairs, and
the electric current may flow through the fluid and the one of the orifices between the first base and the second base to drive the electrochemical reaction of the fluid outputting a first gaseous product at the first base and a second gaseous product at the second base;
a first inlet in the first compartment positioned to discharge the first portion of fluid towards the first base, thereby replenishing the first portion of fluid during the electrochemical reaction;
a second inlet in the second compartment positioned to discharge the second portion of fluid towards the second base, thereby replenishing the second portion of fluid during the electrochemical reaction;
a first drain in the first compartment for collecting a first portion of a solid byproduct of the electrochemical reaction;
a second drain in the second compartment for collecting a second portion of the solid byproduct of the electrochemical reaction;
a first outlet in the first compartment for collecting the first gaseous product of the electrochemical reaction evolved at the first base; and
a second outlet in the second compartment for collecting the second gaseous product of the electrochemical reaction evolved at the second base.

5. The apparatus of claim 4, wherein:
the container comprises a first sidewall and a second sidewall separated from the first sidewall by a depth dimensioned such that the depth determines a gap between the first base and the second base in each of the pairs of the electrodes when the mount mounts:
the first base of the first electrode is flush and/or aligned with the first sidewall, and
the second base of the second electrode flush and/or aligned with the second sidewall, and
each of the first mounts comprise a first opening dimensioned to expose the first base to the fluid; and
each of the second mounts comprise a second opening dimensioned to expose the second base to the fluid; and
wherein the one or more first mounts comprise one or more first openings into which the first electrodes can move along their longitudinal axis so as to be exposed to the fluid and the one or more second mounts comprise second openings into which the second electrodes can move along their longitudinal axis so as to be exposed to the fluid.

6. (canceled)

7. The apparatus of claim 5, further comprising:
a first electrode dispenser positioned to insert the first electrodes through the first openings into the first compartment when at least driving the electrochemical reaction or removing the first electrode once the first electrode is spent by the electrochemical reaction; and
a second electrode dispenser positioned to insert the second electrodes through the second openings into the first compartment when at least driving the electrochemical reaction or removing the second electrode once the second electrode is spent by the electrochemical reaction.

8. The system of claim 7, wherein the first electrode dispenser and the second electrode dispenser each comprise at least one of:
an actuator that automatically advances a length of the electrode into the first compartment or the second compartment and configured to control a distance between the first base and the second base during the electrochemical reaction; or
a magazine for dropping in a new electrode as needed.

9. (canceled)

10. The apparatus of claim 89, further comprising:
one or more control circuits controlling at least one of:
a distance between a first electrode and a second electrode in response to a feedback comprising a measurement of electric current between the first electrode and the second electrode, so that the distance maintains a desired current density of the electric current driving an electrochemical reaction of a fluid in contact with the electrodes, or a static distance between the first base and the second base;
replacement of the electrodes spent by the electrochemical reaction so as to maintain a desired reaction rate of the electrochemical reaction;
reversal of a polarity of the electric current when certain electrode consumption or cleanliness thresholds are met, so as to allow swapping of the first electrode and the second electrode for keeping the electrodes clean and evenly consuming the first electrode and the second electrode; or
manifolding of gaseous products outputted from the electrochemical reaction.

11. The apparatus of claim 4, wherein:
the first outlet is at the top of the first compartment above the first electrode to collect the first gaseous product evolving upwards,
the second outlet is at the top of the second compartment above the second electrode to collect the second gaseous product evolving upwards,
the first inlet is at the base of the first compartment and comprises a first nozzle or conduit propelling a jet of the seawater towards the first base,
the second inlet is at the base of the second compartment and comprises a second nozzle or conduit propelling a jet of the seawater towards the second base,
the first drain is in the base of the first compartment, and
the second drain is in the base of the second compartment.

12. The apparatus of claim 4, wherein the non-conductive barrier comprises a semipermeable membrane covering the orifices.

13. The apparatus of claim 1, further comprising:
a container containing the fluid; and
a driving circuit supplying the electric current flowing between the first electrode and the second electrode when:
the driving circuit is connected to the electrodes mounted in the container,
the fluid comprises seawater or an electrolyte comprising a salt and water,
the electrochemical reaction comprises electrolysis,
the electrolysis outputs a first product, comprising hydrogen, at the first base, and
the electrolysis outputs a second product, comprising oxygen, at the second base, and wherein:
the driving circuit comprises a setting outputting the electric current at a level wherein output of chlorine, from the salt in the fluid at the first or second electrode comprising the anode, is suppressed below a target level comprising a negligible level or non-toxic level.

14. The apparatus of claim 13, further comprising a sensor connected to the container for sensing at least one of the hydrogen or carbon dioxide.

15. The apparatus of claim 1, further comprising a mount mounting one or more pairs of the electrodes, comprising a first electrode comprising the base comprising a first base and the second electrode comprising the base comprising a second base, with the spacing between the first base and the second base in a range of 0.5 cm-3 cm.

16. The apparatus of claim 1, wherein the electrodes have a diameter in a range of 0.5 mm-10 mm and the length in a range of 0.5 cm-2 cm.

17. The apparatus of claim 1, wherein:
the electrodes comprise an electrochemically active material having electrode sidewalls and a coating on the electrode sidewalls but not on the base, and
the coating comprises an electrochemically inactive material that does not participate in the electrochemical reaction.

18. The apparatus of claim 17, wherein:
the electrodes each have a longitudinal axis, and
the coating has a thickness that collapses as the electrochemically active material is consumed and recedes along a direction of the longitudinal axis during the electrochemical reaction, so as to maintain a constant effective area of the base exposed to the fluid during the electrochemical reaction.

19. (canceled)

20. The apparatus of claim 15, wherein the coating comprises at least one of a metal oxide, a metal nitride, a metal fluoride, or a compound thereof.

21. The apparatus of claim 1, wherein the electrochemically active material comprises, consists of, or consists essentially of metal, carbon, graphite, graphene, one or more rolled graphene sheets, or carbon nanotubes.

22. The apparatus of claim 1, further comprising an array comprising a plurality of the pairs of the electrodes, wherein:
the array comprises a 1 dimensional array of the electrodes comprising the first electrodes in the pairs disposed along a first line and the second electrodes in the pairs disposed along a second line, or
a two dimensional array of the electrodes, comprising:
the first electrodes disposed in a repeating pattern or lattice of a first unit cell defined by a first spacing in a first direction and a second spacing in a second direction; and
the second electrodes disposed in a repeating pattern or lattice of a second unit cell defined by the first spacing in the first direction direction and a second spacing in a second direction.

23. (canceled)

24. (canceled)

25. The apparatus of claim 1, wherein the pairs of the electrodes comprise a first electrode and the second electrode comprise at least one of:
different lengths, or
different widths, or
a taper or a width that varies along a length of the first electrode or the second electrode.

26. The apparatus of claim 1, wherein the electrodes each comprise at least one of:
a cylinder, a tube, a rod, or a polyhedron having a cross section comprising a polygon or circle and the first base and the second base each comprise a base of the cylinder, the tube, the rod, or the polyhedron, or
symmetry about the longitudinal axis of the electrodes.

27. (canceled)

28. (canceled)
